(19) United States
(12) Patent Application Publication
(10) Pub. No.: US 2026/0231102 A1
(43) Pub. Date: Aug. 6, 2026

(54) SYSTEMS AND METHODS FOR DYNAMIC SYNCHRONIZATION AND INTERFERENCE MITIGATION IN REAL-TIME LOCATION SYSTEMS

(71) Applicant: Cisco Technology, Inc., San Jose, CA (US)

(72) Inventors: Navid Reyhanian, Fremont, CA (US); Ardalan Alizadeh, Campbell, CA (US); Peiman Amini, Fremont, CA (US); Jerome Henry, Pittsboro, NC (US)

(21) Appl. No.: 19/408,354

(22) Filed: Dec. 4, 2025

Related U.S. Application Data
(60) Provisional application No. 63/753,922, filed on Feb. 4, 2025.

(51) Int. Cl. H04W 64/00; G06F 1/12

(52) U.S. Cl. CPC H04W 64/00; G06F 1/12

(57) ABSTRACT

Systems and methods for dynamic anchor coordination and interference mitigation within Ultra-Wideband (UWB) real-time location systems are disclosed. The system creates a self-healing infrastructure by continuously monitoring anchor metrics, such as local tag density and packet collision probabilities, to detect impaired primary anchors. When instability is detected, the coordination logic identifies a suitable secondary anchor operating in a cleaner radio frequency environment and dynamically re-assigns it to the primary synchronization role. To further enhance reliability in harsh environments, the system utilizes adaptive repetitive synchronization, wherein critical timing messages are broadcast across multiple, non-consecutive transmission slots within a single ranging round. Additionally, the system aggregates interference data to construct a network-wide map, allowing for the real-time detection of persistent slot collisions. Upon identifying a compromised slot, the logic automatically re-tasks anchors to transmit on clean resources, ensuring robust clock alignment and precise asset tracking despite dynamic congestion.

### CROSS-REFERENCE TO RELATED APPLICATION

This application claims the benefit of priority to U.S. Provisional Patent Application No. 63/753,922, filed Feb. 4, 2025, the disclosure of which is incorporated by reference herein in its entirety.

The present disclosure relates to real-time location systems. More particularly, the present disclosure relates to dynamically coordinating anchor roles and adjusting synchronization transmission parameters to mitigate interference within ultra-wideband network environments.

### BACKGROUND

Real-time location systems (RTLS) have become increasingly integral to enterprise operations across various industries, including healthcare, manufacturing, and logistics. These systems enable organizations to track the physical location of assets, equipment, and personnel, thereby improving operational efficiency, safety, and asset utilization. While earlier iterations of these systems relied on technologies such as Wi-Fi or Bluetooth Low Energy (BLE), the demand for higher precision has driven the adoption of Ultra-Wideband (UWB) technology, which offers superior ranging accuracy and interference resilience.

In a typical UWB-based RTLS deployment, a network of fixed infrastructure devices, often referred to as anchors or access points, is installed throughout a facility. Mobile devices or tags attached to assets periodically transmit radio frequency signals, commonly known as blinks, which are received by the surrounding anchors. By measuring the precise time of arrival (ToA) of these signals at multiple synchronized anchors, the system can calculate the time difference of arrival (TDoA) to determine the tag's location. To ensure accurate localization, the anchors themselves must maintain tight time synchronization, often achieved through the periodic exchange of clock synchronization packets within the network infrastructure.

As these deployments scale to cover larger areas and support higher densities of tracked assets, the radio frequency environment can become increasingly congested. The simultaneous transmission of tag blinks and synchronization messages requires careful coordination to minimize signal collisions and maintain system integrity. Furthermore, the physical geometry of the deployment and the distances between infrastructure nodes can influence the stability of clock synchronization across the network.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration depicting various subsets of artificial intelligence in accordance with various embodiments of the disclosure;

FIG. 2 are conceptual illustrations depicting different methods of machine-based learning in accordance with various embodiments of the disclosure;

FIG. 3 is a conceptual illustration depicting a machine learning lifecycle in accordance with various embodiments of the disclosure;

FIG. 4 is a conceptual illustration depicting an exemplary neural network in accordance with various embodiments of the disclosure;

FIG. 5 is a diagram illustrating a timeline for adaptive repetitive synchronization utilizing multiple transmission slots in accordance with various embodiments of the disclosure;

FIG. 6 is a conceptual diagram 600 illustrating a dynamic slot allocation state in accordance with various embodiments of the disclosure;

FIG. 7 is a schematic diagram of a physical environment illustrating dynamic anchor role assignment based on tag density in accordance with various embodiments of the disclosure;

FIG. 8 is a schematic diagram of a network deployment environment connecting local access points to remote services in accordance with various embodiments of the disclosure;

FIG. 9 is a flowchart showing a process for dynamic anchor role assignment and stability verification in accordance with various embodiments of the disclosure;

FIG. 10 is a flowchart showing a process for adaptive repetitive synchronization based on environmental harshness in accordance with various embodiments of the disclosure;

FIG. 11 is a flowchart showing a process for dynamic synchronization slot allocation and interference sensing in accordance with various embodiments of the disclosure; and

FIG. 12 is a conceptual block diagram for one or more network devices capable of executing anchor coordination logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

### Overview

In some embodiments, an access point, includes a processor, a transceiver configured to transmit synchronization messages to a plurality of anchors in a real-time location system (RTLS), and a memory communicatively coupled to the processor, wherein the memory includes an anchor coordination logic. The logic is configured to monitor a synchronization quality of a network environment, determine that the synchronization quality is degraded, calculate a number of redundant transmission slots required based on the synchronization quality, and transmit a synchronization message in a default slot and in the determined number of redundant transmission slots within a single ranging round.

In some embodiments, a method of dynamic anchor coordination includes monitoring, by a network controller, one or more anchor metrics associated with a plurality of anchors in communication with a real-time location system (RTLS), wherein at least one of the plurality of anchors is assigned as a primary anchor, determining, by the network controller, based on the anchor metrics, that the primary anchor is operating in an impaired state, identifying, by the network controller, a suitable secondary anchor from the plurality of anchors, re-assigning, by the network controller, the current primary anchor to a secondary anchor role, and re-assigning, by the network controller, the suitable secondary anchor as the new primary anchor.

### Example Embodiments

In light of the issues addressed above, network administrators and system designers continually seek methods to enhance the robustness of synchronization mechanisms and improve the overall reliability of location services in complex, dynamic environments. For example, real-time location systems (RTLS) have become essential for operational efficiency in industries such as healthcare, manufacturing, and logistics, yet the increasing density of tracked assets presents significant challenges to network stability. Traditional UWB systems often rely on a static primary anchor to broadcast synchronization signals, which creates a single point of failure if that anchor becomes congested by local tag traffic. As tag density rises, the probability of blink messages colliding with critical clock synchronization packets increases, leading to a degradation of the entire system's timing domain. Furthermore, physical obstructions and environmental noise can cause intermittent signal loss, making it difficult for secondary anchors to maintain tight clock alignment with a distant primary node. There is a pressing need for an infrastructure that can dynamically adapt its topology and transmission behavior to overcome these localized interference events without requiring manual reconfiguration.

Embodiments of the present disclosure address these issues by implementing a dynamic anchor role assignment mechanism. The system continuously monitors the health metrics of the primary anchor, including various rates and local tag density. If the primary anchor is determined to be impaired due to congestion, the anchor coordination logic automatically identifies a suitable secondary anchor located in a cleaner radio frequency environment. The system then executes a role swap, promoting the stable secondary anchor to the primary role and demoting the congested node. This self-healing capability ensures that the critical synchronization source is always positioned in the optimal location relative to the current interference landscape, preserving the integrity of the network clock.

To further mitigate the impact of harsh radio frequency environments, various embodiments utilize an adaptive repetitive synchronization scheme. Instead of relying on a single transmission slot for the clock synchronization packet, the primary anchor can broadcast the message across multiple, non-consecutive slots within the same ranging round. For example, the system might transmit on subsequent slots such 3 or 13 for example, ensuring that even if the first two transmissions are corrupted by random tag blinks, the third transmission has a high probability of success. This redundancy is scaled dynamically based on the measured harshness of the environment, allowing the system to maximize reliability during interference spikes while conserving bandwidth when the spectrum is clean.

In addition to redundancy, the system employs real-time interference sensing to optimize slot allocation. Anchors actively listen to the synchronization slots to detect persistent collision patterns caused by rogue devices or misconfigured tags. By aggregating this data into a network-wide interference map, the coordination logic can identify specific time slots that are compromised. The system then automatically re-tasks the anchors to transmit on “clean” slots that are free from persistent noise. This frequency agility allows the infrastructure to “hop” over interference, maintaining robust communication channels even in the presence of uncooperative external signals.

Finally, the combination of these mechanisms creates a resilient, self-optimizing network architecture. By integrating dynamic role assignment, adaptive redundancy, and intelligent slot reallocation, the system can maintain high-precision localization even in the most challenging high-density environments. The logic operates autonomously at the edge, allowing the network to respond to transient issues in milliseconds without waiting for cloud intervention. This comprehensive approach ensures that enterprise RTLS deployments can scale to support thousands of assets while delivering the consistent, sub-meter accuracy required for critical business applications.

As those skilled in the art will recognize, Artificial Intelligence (AI) is a broad field within computer science focused on creating systems that can simulate aspects of human intelligence. These systems can range from simple rule-based programs to sophisticated models capable of learning, adapting, and making decisions based on data. AI spans various branches, including robotics, computer vision, natural language processing, and reinforcement learning, each aiming to enable machines to perform tasks that traditionally require human cognition. The potential of AI lies in its ability to enhance decision-making, improve efficiency, and even drive innovation across industries. With rapid advancements in computational power and algorithm design, AI is becoming increasingly embedded in our daily lives, powering applications from personal assistants to autonomous vehicles and even aiding in scientific research and complex problem-solving.

Machine learning (ML) is a crucial subset of AI that involves systems learning from data to make predictions or decisions without being explicitly programmed for each task. Unlike traditional software, which relies on hard-coded rules, machine learning systems use algorithms that identify patterns and adjust their behavior based on experience. ML includes various techniques, such as supervised learning, unsupervised learning, and reinforcement learning, each suited to different kinds of tasks. For example, supervised learning is commonly used in classification tasks, while reinforcement learning drives decision-making in dynamic environments. ML serves as the foundation for many modern AI applications, as it enables systems to generalize from data and improve over time. As such, ML systems are central to the development of more advanced AI models and applications, including those that require nuanced understanding, like image recognition and language processing.

Those skilled in the art will recognize that an asset tracking device, often referred to as an asset tag, can be understood as a small, battery-powered hardware unit designed to be physically attached to mobile or stationary equipment to monitor its location and status. These devices typically function by intermittently transmitting signals, such as unique identifiers or telemetry data, to a surrounding network infrastructure which then calculates the device's position. In many deployments, these tags are engineered with a primary focus on energy efficiency, utilizing sleep modes and low-power sensors to operate for multiple years without requiring battery replacement, thereby reducing the maintenance burden in large-scale facilities like hospitals or warehouses.

In various embodiments, these devices evolve beyond simple beaconing transmitters into intelligent edge computing nodes capable of processing environmental data locally. Modern asset tracking devices may incorporate microcontrollers with dedicated hardware accelerators that allow them to run machine learning inference algorithms directly on the device. This onboard intelligence enables the tag to distinguish between different types of motion events, such as the rhythmic vibration of a forklift versus the chaotic tumbling of a fall, allowing the device to make autonomous decisions about when to transmit data and which communication protocol to use, rather than relying solely on continuous, power-intensive streaming to a central server.

Often, a Real-Time Location System (RTLS) can be understood as a technological framework used to automatically identify and track the location of objects or people in real time, usually within a building or other contained area. Unlike Global Positioning Systems (GPS) which rely on satellites and function best outdoors, an RTLS is designed for indoor environments where satellite signals cannot penetrate. These systems typically consist of identifying tags attached to assets or worn by people, which transmit wireless signals to a network of fixed reference points, often called anchors or readers, distributed throughout the facility. The data collected by these receivers is then processed by a central software engine to calculate the precise coordinates of the tags on a map. This capability allows organizations to visualize their operations, locating everything from medical equipment in a hospital to pallets in a warehouse instantly.

In various embodiments, the utility of an RTLS extends beyond simple dot-on-a-map tracking to include complex workflow automation and safety monitoring. For instance, the system can be configured to trigger alerts if a high-value asset leaves a designated secure zone, or to analyze traffic patterns to optimize the layout of a manufacturing floor. The “real-time” aspect implies that the system updates location data frequently enough to track movement as it happens, rather than just providing a snapshot of where items were in the past. To achieve this, the system must balance the frequency of location updates with the battery life of the tags and the available bandwidth of the wireless network. As the density of tracked items increases, the system requires sophisticated coordination to ensure that the thousands of signals generated do not interfere with one another, preserving the integrity and timeliness of the location data.

Those skilled in the art will recognize that Ultra-Wideband (UWB) is a radio communication technology that uses a very low energy level for short-range, high-bandwidth communications over a large portion of the radio spectrum. Unlike traditional narrowband radio systems that transmit on a specific frequency, UWB transmits information by generating radio energy at specific time intervals and occupying a large bandwidth, often exceeding five-hundred megahertz. This technique involves transmitting extremely short pulses, often in the range of nanoseconds or picoseconds. Because these pulses are so short in the time domain, they are spread out across a wide frequency range, which allows UWB signals to coexist with other radio frequency technologies without causing significant interference. Furthermore, the wide bandwidth allows UWB to penetrate obstacles like walls and equipment more effectively than many other wireless technologies, making it particularly well-suited for complex indoor environments.

In various embodiments, the primary advantage of UWB in location systems is its exceptional precision in measuring distance. The sharpness of the UWB pulses allows receivers to measure the time of flight of a radio signal with high accuracy, often resulting in location precision down to a few centimeters. This is a significant improvement over technologies based on signal strength, like Wi-Fi or Bluetooth, which can be heavily influenced by environmental factors and signal attenuation. Additionally, UWB is highly resistant to the multipath effect, a phenomenon where radio signals bounce off walls and floors, arriving at the receiver at different times. The distinct, short pulses of UWB allow the receiver to distinguish the direct path signal from the reflected signals, ensuring that the calculated distance is based on the true straight-line path between the transmitter and the receiver.

Often, Bluetooth Low Energy (BLE) can be understood as a wireless personal area network technology designed and optimized for applications requiring low power consumption and short-range communication. Unlike classic Bluetooth, which is designed for continuous data streaming applications like audio, BLE is intended for transmitting small amounts of data in short bursts, making it an ideal communication standard for battery-operated asset tags that need to periodically advertise their presence. The protocol utilizes a technique known as advertising, where the device broadcasts packets containing its identity and status on specific frequency channels, allowing scanning infrastructure devices like access points to detect the tag without establishing a full, energy-consuming connection.

In a number of embodiments, BLE serves as the default or “heartbeat” transmission mode for asset tracking systems due to its minimal energy impact. It is frequently utilized for determining proximity-based location, where the signal strength (Received Signal Strength Indicator or RSSI) of the broadcasted packet is measured to estimate the distance between the tag and the receiver. While this method provides a coarse location suitable for identifying which room or zone an asset is in, it allows the system to maintain general visibility of thousands of assets simultaneously without overwhelming the radio frequency spectrum or draining the device batteries.

In various embodiments, Time Difference of Arrival (TDoA) is a positioning technique used to determine the location of a transmitting source based on the difference in time it takes for a signal to reach multiple receivers. Instead of measuring the absolute distance between a tag and an anchor, which would require the tag and anchor to exchange messages to measure the round-trip time, TDoA systems rely on the tag sending a single, one-way message. When this message is received by multiple synchronized anchors, the system records the precise timestamp of arrival at each node. By comparing these timestamps, the system can calculate the difference in distance the signal traveled to reach each anchor. Mathematically, a constant difference in distance between two points defines a hyperbola, and the intersection of multiple hyperbolas derived from multiple anchor pairs pinpoints the specific location of the tag.

Often, the critical requirement for a TDoA system is that all receiving anchors must share a highly accurate, synchronized common clock. Since radio signals travel at the speed of light, a timing error of just a few nanoseconds can translate into meters of positioning error. Therefore, the infrastructure must continuously exchange synchronization packets to account for the minute drift that occurs in electronic clocks over time. If the primary source of this time synchronization becomes unstable or obstructed, the ability of the surrounding anchors to compare timestamps accurately is compromised, leading to a degradation of the entire location system. This sensitivity makes the management of the synchronization source and the protection of synchronization signals from interference a paramount concern in the design of TDoA-based networks.

Those skilled in the art will recognize that a network anchor is a fixed infrastructure device that serves as a reference point for locating mobile tags within the deployment environment. These devices are typically mounted at known coordinates on walls or ceilings and are equipped with wireless radios capable of receiving and timestamping signals from asset tags. Anchors effectively act as the bridge between the physical radio frequency environment and the digital network, converting analog radio pulses into digital time data that can be processed by a server. In addition to listening for tags, anchors often communicate with each other to maintain system health, exchange configuration parameters, and, crucially, synchronize their internal clocks.

In various embodiments, anchors can dynamically assume different roles within the network hierarchy to optimize performance. A primary anchor, or leader, may take on the responsibility of broadcasting the master timing signal that keeps the cluster aligned. Secondary anchors, or followers, listen for this signal to correct their own local times while simultaneously listening for tag blinks. Because the primary anchor is a single point of truth for the local time domain, its operational stability is critical. Advanced systems can monitor the health of the primary anchor and, if congestion or hardware fault is detected, automatically promote a suitable secondary anchor to take over the leadership role, ensuring the continuous operation of the location service without manual intervention.

Often, a ranging round can be understood as a discrete unit of time within the wireless communication protocol during which a specific sequence of operations occurs. To organize the chaotic traffic of a wireless network, time is often divided into repeating structures, or blocks, which are further subdivided into these rounds. A single round might last for a fraction of a second, such as 125 milliseconds, and serves as a container for both infrastructure management and asset tracking activities. By rigidly defining the duration and structure of a round, the system ensures that all devices know exactly when to transmit and when to listen, minimizing the likelihood of signal collisions.

In various embodiments, a ranging round is internally partitioned into distinct phases to separate critical control signals from random data traffic. For example, the beginning of a round may be reserved exclusively for high-priority synchronization messages between anchors, a period where no tags are allowed to transmit. Following this control phase, the remainder of the round provides a larger window for receiving the uncoordinated blinks from the multitude of asset tags in the environment. This structure allows the system to prioritize the stability of the network infrastructure over the tracking of any single item. Furthermore, the logic controlling these rounds can utilize redundancy, transmitting critical data in multiple different time slots within the same round to ensure it survives in harsh radio frequency environments.

Those skilled in the art will recognize that Linear Interpolation can be understood as a method of curve fitting using linear polynomials to construct new data points within the range of a discrete set of known data points. It essentially involves drawing a straight line between two adjacent known values and estimating the value of a point at a specific location along that line. This technique is computationally efficient and simple to implement, making it a standard tool in digital signal processing for resampling data or filling in missing information without requiring complex higher-order mathematical functions.

In various embodiments, linear interpolation is utilized to reconstruct a usable motion profile from sensor data that was collected at a reduced sampling rate to save power. When a device lowers its polling frequency, it creates temporal gaps between sensor readings; linear interpolation allows the system to estimate the likely position or acceleration of the asset during those gaps. This reconstruction ensures that the tracking logic can still process a continuous stream of data for trajectory analysis or visualization, minimizing the loss of fidelity that would otherwise occur due to the aggressive power-saving measures.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many other acquired instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and acquired features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

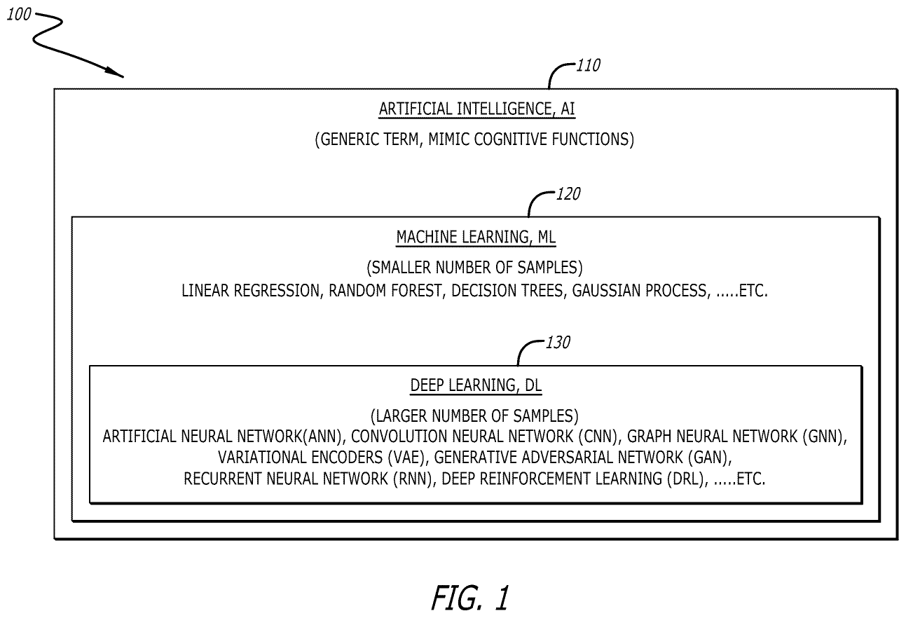

Referring to FIG. 1, a diagram 100 depicting various subsets of artificial intelligence in accordance with various embodiments of the disclosure is shown. Artificial intelligence (AI 110) is typically understood in the art to be the development of machines and algorithms that mimic human intelligence, for example, by optimizing actions to achieve certain goals. At its core, AI 110 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 110 can be considered a generic term because it encompasses a wide range of subfields and techniques, from simple rule-based systems to advanced machine learning and deep learning models. These AI techniques are used to simulate various aspects of human cognition. For example, machine learning (ML 120) allows computers to learn from data patterns without explicit programming for each task, while natural language processing (NLP) enables machines to understand and generate human language. Deep learning (DL 130), a more advanced branch of AI, uses neural networks to automatically learn complex patterns from large datasets, akin to the human brain's information processing.

This versatility makes AI a powerful tool across diverse applications, including image recognition, autonomous driving, voice assistants, healthcare diagnostics, and materials discovery. A goal of AI is often to create systems that can function autonomously and intelligently in real-world scenarios. As AI 110 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML 120) is a subset of Artificial Intelligence (AI 110) that focuses on the development of algorithms and statistical models that enable computers to learn and make decisions from data without explicit programming. In traditional programming, a computer is given a fixed set of rules to follow, but ML 120 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases.

In various embodiments described herein, machine-learning methods may be utilized to determine camera angles, control virtual camera movement, and optimize scene composition within an interactive game. ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results.

Techniques like linear regression, decision trees, random forests, and Gaussian processes are commonly used in ML 120. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from historical gameplay sessions, cinematographic rule sets, user feedback, among other sources.

However, traditional ML methods rely heavily on feature engineering, wherein human experts manually identify the most relevant features or patterns within the data. For example, when using ML 120 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than one-hundred) to learn effectively.

Deep Learning (DL 130) is a specialized subset of Machine Learning (ML 120) that employs multi-layered artificial neural networks to automatically learn complex patterns and representations from large, often unstructured datasets. Inspired by the way the human brain processes information, DL 130 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 130 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials.

RNNs and their variants, such as Long Short-Term Memory (LSTM) networks, are suited for sequential data like time series or natural language processing, allowing for the analysis and generation of textual information or the prediction of temporal patterns in scientific research. One of the defining characteristics of deep learning is its requirement for large datasets (typically over five-hundred samples for example) to effectively train neural networks. The deep, multi-layered structure of these networks enables them to capture highly complex and abstract representations of the data, but it also demands significant computational power.

Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML 120 neural network designed to work particularly well with image data, making them highly relevant for analyzing in-game camera feeds and visual scene composition. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering.

Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction, such as identifying optimal framing or detecting visual occlusions. While CNNs are well-suited for grid-based data like images, many real-world problems in can involve non-grid data, such as scene graph relationships, character interactions, or spatial layouts.

This type of data may better be represented as a graph, where nodes represent entities (e.g., game objects) and edges represent relationships between them (e.g., spatial proximity). Thus, Graph Neural Networks (GNNs) can be utilized to operate on such graph-based data. In GNNs, information is passed between nodes through edges in a process called message passing. This allows the network to capture dependencies and relationships within the graph structure. The key feature of GNNs is their ability to aggregate information from neighboring nodes, which is crucial in predicting properties that depend on the current/local structure, such as the behavior of an asset or the properties of a virtual camera.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to construct a potential camera trajectory or the like.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. This type of process may be utilized to compare camera cuts to a realistic cinematographic output.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex camera simulations.

In interactive games, DRL can be used in scenarios where an optimal decision needs to be made, such as optimizing a camera cut location or finding the best configuration for a camera movement based on the desired or current properties of the camera(s). The combination of RL and DL can allow for learning from raw data, making it a powerful tool for dynamic and real-time decision-making within an interactive game.

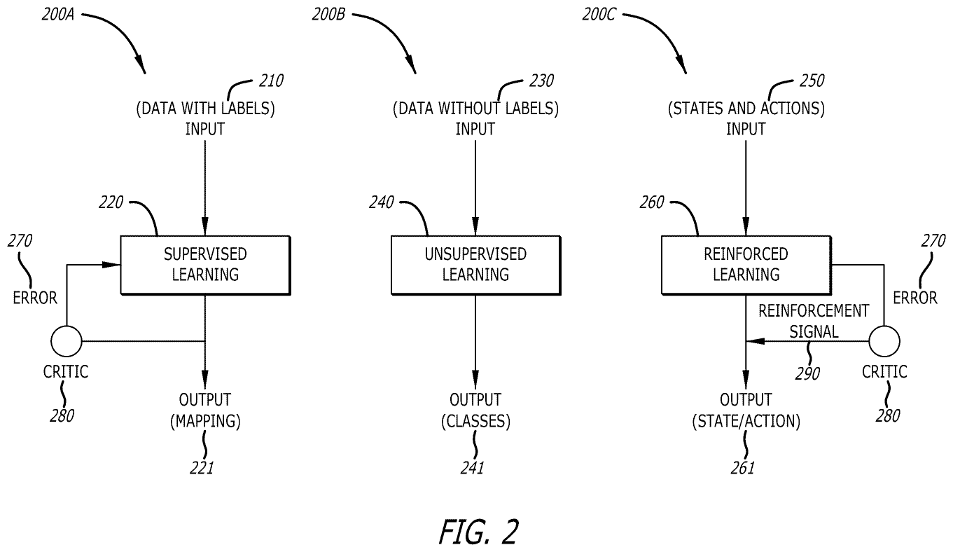

Although a specific embodiment for a diagram 100 depicting various subsets of artificial intelligence suitable for carrying out the various steps, processes, methods, and operations described herein is discussed with respect to FIG. 1, any of a variety of systems and/or processes may be utilized in accordance with embodiments of the disclosure. For example, other subsets may be present and available for use within AI 110. Those skilled in the art will recognize that the diagram 100 presented in FIG. 1 is simplified for illustration purposes and various methods and techniques may interact with other areas (ML 120 with DL 130, etc.). The elements depicted in FIG. 1 may also be interchangeable with other elements of FIGS. 2-12 as required to realize a particularly desired embodiment.

Referring to FIG. 2, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 2, a supervised learning system 200A is shown. The supervised learning system 200A can be configured with a supervised learning model 220 that accepts input data 210 and generates an output 221. However, the output data is often reviewed by a critic 280 that can determine one or more errors 270 that are fed back into the supervised learning model 220 via one or more reinforcement signals 290 for use in updating.

A supervised learning system 200A can often be considered the simplest machine learning model to understand in which input data (such as training data) has a known label or result as an output. So, the supervised learning model 220 can be understood to work on the principle of input-output pairs. As such, a function can be trained using a training data set, which is then applied to unknown data and makes some predictive performance. Supervised learning is task-based and mostly tested on labeled data sets.

A supervised learning system 200A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values.

As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to various camera cut options and the resulting score of the cut. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a certain layout is suitable for a camera cut, etc. Classification algorithms can also be used to predict between two or more classes and/or categorize an output into different groups. For these classification systems, a classifier model can be designed that classifies the dataset into different categories, and each category can subsequently be assigned a label.

As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve(independent) assumption between the features which is often given as the formula:

P(y|X)=(P(X|y)*P(y))/(P(X))

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features. Likewise, various embodiments herein can classify based on camera type, camera direction, point of interest present, etc.

Again, in the embodiment depicted in FIG. 2, an unsupervised learning system 200B is shown. The unsupervised learning system 200B can be configured with an unsupervised learning model 240 that accepts input data 230 and generates an output 241. Unlike other model types, there are no critics or error signals to process. An unsupervised learning model 240 can implement the learning process opposite to supervised learning, which means it enables the model to learn from an unlabeled training dataset. Based on the unlabeled dataset, the unsupervised learning model 240 can predict the output. Using an unsupervised learning system 200B, the unsupervised learning model 240 can learn hidden patterns from the dataset by itself without any supervision.

In various embodiments, an unsupervised learning model 240 can often be utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to generate a camera cut with a maximized overall camera score. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 2, a reinforcement learning system 200C is shown. The reinforcement learning system 200C can be configured with a reinforcement learning model 260 that accepts input data 250 and generates an output 261. In reinforcement learning, the reinforcement learning model 260 learns actions for a given set of states that lead to a goal state. In the embodiment depicted in FIG. 2, a critic 280 can receive or otherwise notice one or more errors 270 within the reinforcement learning model 260 actions, and adjust the outcome/output such that the “reward” or “punishment” is adjusted to better model the future behaviors or processing of the reinforcement learning model 260.

It is a feedback-based learning model that can take feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 2, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 2 may also be interchangeable with other elements of FIGS. 1 and 3-12 as required to realize a particularly desired embodiment.

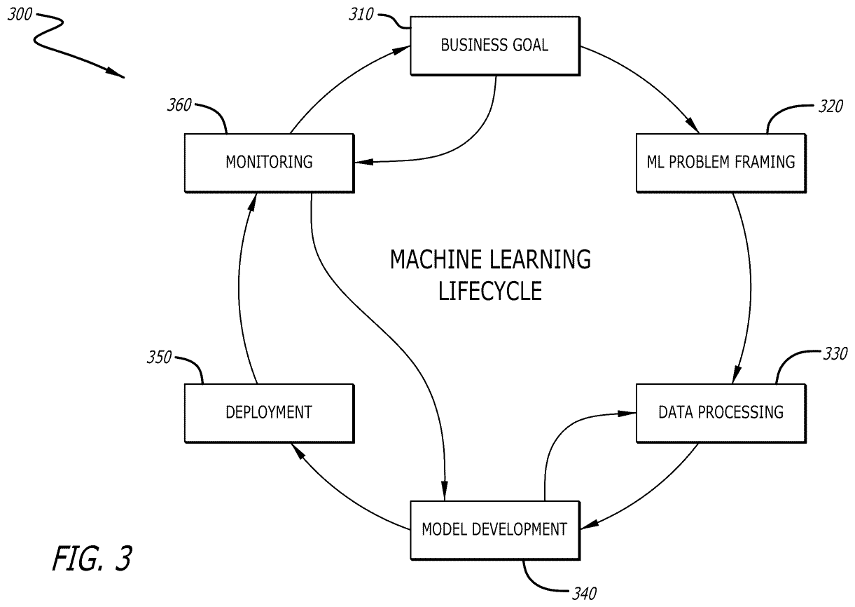

Referring to FIG. 3, a machine learning lifecycle 300 in accordance with various embodiments of the disclosure is shown. During the development of machine learning systems, the embodiment depicted in FIG. 3 can provide a framework for how to structure the design and maintenance of these systems. This machine learning lifecycle 300 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 300 emphasizes that developing a machine learning model is not a one-time effort but an iterative process requiring ongoing monitoring and adjustment. The feedback loop inherent in the machine learning lifecycle 300 allows for continual refinement and optimization of models to maintain their accuracy and relevance.

In many embodiments, a first stage of the machine learning lifecycle 300 is identifying the business goal 310, which sets the overall direction and purpose of the ML project. This can involve understanding the specific problems or opportunities within the business or project that machine learning can address. A business goal 310 that is clear can ensure that the project remains focused on delivering tangible value, whether it is improving player experiences, optimizing gametime operations, predicting camera cuts, or automating camera movements. Without a well-defined goal, it can be challenging to align the subsequent stages of the machine learning lifecycle 300, as the choice of model, data processing methods, and performance metrics can all depend on what the business aims to achieve.

Establishing a business goal 310 properly can also involve engaging with key stakeholders and developers to gather requirements and set success criteria. It can provide a roadmap that outlines what success looks like and helps in framing the ML problem. For example, if the goal is to reduce processor overhead, the project might focus on building a predictive model that identifies potential bottlenecks, allowing the game engine to intervene proactively. Clearly defined goals not only help guide the project but also provide benchmarks for evaluating the effectiveness of the deployed model once it enters production.

Once the business goal 310 is established, various embodiments take a next step involving ML problem framing 320, wherein the goal is translated into a specific machine learning task. This can involve selecting the appropriate type of ML problem, such as classification, regression, clustering, or recommendation, and defining the target variables or outputs. For example, if the goal is to identify processor bottlenecks, the problem can be framed as a binary classification task where the model predicts whether a certain number of assets will cause the game engine to slow down. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 330 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 330 can require or at least benefit from careful planning and iterative refinement. Once the data is processed, it is typically split into training, validation, and test sets to develop and evaluate the model, ensuring that it generalizes well to new, unseen data.

Model development 340 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 340, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 330.

In further embodiments, deployment 350 is the stage where the developed model is integrated into the production environment to perform its intended tasks. This phase may involve setting up the necessary infrastructure, such as APIs or cloud-based services, to allow the model(s) to process live data and generate predictions. Deployment 350 can transform the model from a research tool into a functional component of a business process or product, providing real-time insights, automations, or decisions.

The deployment 350 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 310.

In more embodiments, monitoring 360 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 360, teams can identify when the model's performance drops and requires retraining or adjustments to align with the evolving data.

Monitoring 360 can also encompass aspects like user feedback, security, and compliance, ensuring that the model remains effective, reliable, and ethical in its application. It may serve as the feedback loop in the lifecycle, where insights gained from monitoring feed back into the earlier stages, such as data processing 330 and model development 340, to refine the model(s) as needed. This iterative process allows the machine learning system to adapt and maintain its alignment with the business goal 310 over time.

Although a specific embodiment for a machine learning lifecycle 300 suitable for carrying out the various steps, processes, methods, and operations described herein is discussed with respect to FIG. 3, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aid in development and refinement of different model(s). The elements depicted in FIG. 3 may also be interchangeable with other elements of FIGS. 1-2 and 4-12 as required to realize a particularly desired embodiment.

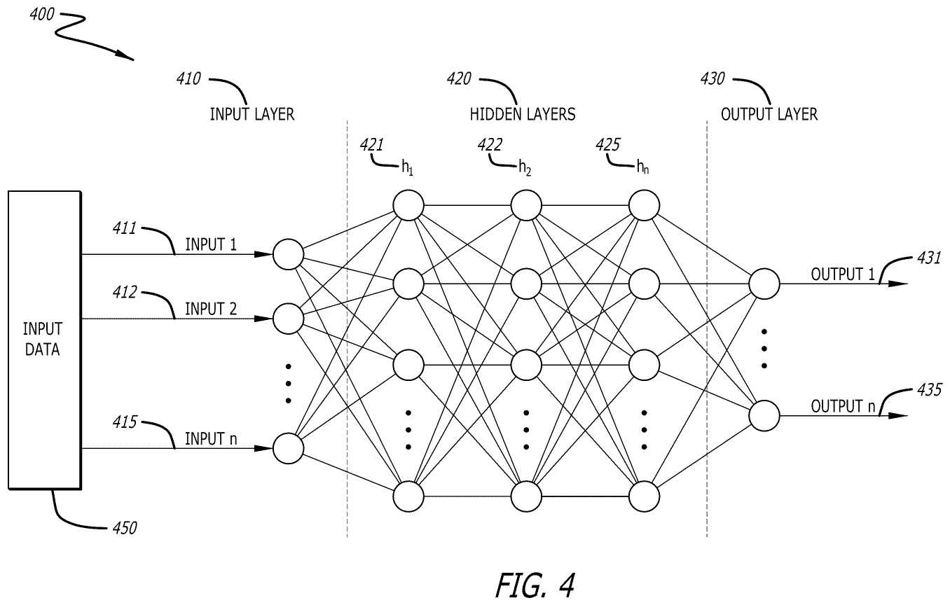

Referring to FIG. 4, a neural network 400 in accordance with various embodiments of the disclosure is shown. The embodiment depicted specifically depicts a feedforward neural network with multiple layers. This type of network consists of an input layer 410, one or more hidden layers 420, and an output layer 430. Each layer contains nodes (or neurons) that are interconnected, representing how data flows through the network. The input layer 410 can receive raw data, which is then processed by the one or more hidden layers 420 through weighted connections and activation functions. These one or more hidden layers 420 can enable the network to learn complex patterns and relationships within the data.

The output layer 430 produces the network's predictions or classifications based on the processed input. The interconnected nature of the nodes allows the neural network 400 to learn from data during training by adjusting the weights of connections to minimize prediction errors. This structure is the foundation of deep learning models, as adding one or more hidden layers 420 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 400 depicted in the embodiment of FIG. 4, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 4 is presented as an exemplary ML solution that may be deployed within one or more methods or systems described herein.

In many embodiments, the input layer 410 is the first layer in a neural network 400 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 400 are generally scaled i.e., normalized to have a zero mean and/or unit standard deviation. Scaling can also be applied to the input of hidden layers (using batch or layer normalization) to improve the stability of neural network 400.

Unlike the one or more hidden layers 420 and output layer 430, the input layer 410 typically does not perform any computations or transformations on the data. Its primary function is often to pass the input data to the next layer in the network, the first hidden layer 421. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 410 itself does not modify the data, it sets the stage for the neural network to extract complex patterns and relationships through the deeper layers. This flexibility in handling various types of input make the neural network 400 a powerful tool for a diverse set of applications.

With respect to the embodiments described herein, the input layer may be configured with a plurality of inputs providing camera data 450, camera attributes/parameters or other data sources. For example, a model can be configured with a first input 411 configured as a first potential camera to cut to, a second input 412 is configured with a second potential camera to cut to, while additional inputs can be added related to the number of potential cameras in the system. The nth input 415 can be configured in certain embodiments to include the current camera such that a determination to keep the current camera in place may be possible. However, as those skilled in the art will recognize, additional setups can be configured such that the inputs can be configured to also include different parameters of the cameras, the number of assets or points of interest in the scene, the overall camera scores of previous analyses, among other input types, etc.

In a number of embodiments, the neural network 400 comprises one or more hidden layers 420. The embodiment depicted in FIG. 4 comprises a first hidden layer 421, a second hidden layer 422, and an nth hidden layer 425, which are denoted as h1, h2, and hn respectively. In many embodiments, the one or more hidden layers 420 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 421 h1 receives direct input from the input layer, transforming the raw data into an initial set of features. For example, in an image recognition task, this layer might begin identifying basic patterns, such as edges or simple textures. The output of the first hidden layer 421 is then passed to a second hidden layer 422 h2, which builds upon the features identified by the first hidden layer 421. This deeper layer might start recognizing more complex patterns, such as shapes or specific object components, by combining the lower-level features identified earlier. This can continue on until a last, nth hidden layer 425 hn continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the input layer 410 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 430 is often the final layer in a neural network and is responsible for producing the network's predictions or classifications based on the information processed through the one or more hidden layers 420. Each neuron in the output layer 430 can represent a specific outcome or category that the model can predict. In the embodiment depicted in FIG. 4, the outputs are labeled as “output 1” to “output n,” indicating that the network can be designed to have a varying number of outputs depending on the nature of the problem being solved for. For example, in a binary classification task (e.g., cutting the camera vs. not cutting the camera), there would typically be a single output neuron that provides a probability score for one of the two classes/outcomes. In contrast, for multi-class classification (e.g., categorizing a best suited camera cut between three or more potential cameras and/camera angles), the output layer would contain multiple neurons, each corresponding to a different class.

The number of neurons in the output layer 430 can also be designed specifically for other types of tasks, such as regression, where the model can predict continuous values. In such cases, the output layer 430 might contain a single neuron representing a numerical prediction, such as the price of a house or the temperature forecast, etc. Alternatively, in complex applications like multi-label classification (where each input can belong to multiple classes simultaneously), the output layer 430 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a SoftMax function can be applied to output a set of probabilities that sum to 1, indicating the most likely class. For regression problems, a linear activation function is often used to output a continuous range of values. The flexibility in designing the output layer allows the neural network 400 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 4, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 4, which is an illustrative example meant to make it easier to explain the basic concepts of neural networks and how they process information. The specific features and functions described herein are not intended to be limiting to this specific embodiment. Additionally, the elements depicted in FIG. 4 may also be interchangeable with other elements of FIGS. 1-3 and 5-12 as required to realize a particularly desired embodiment.

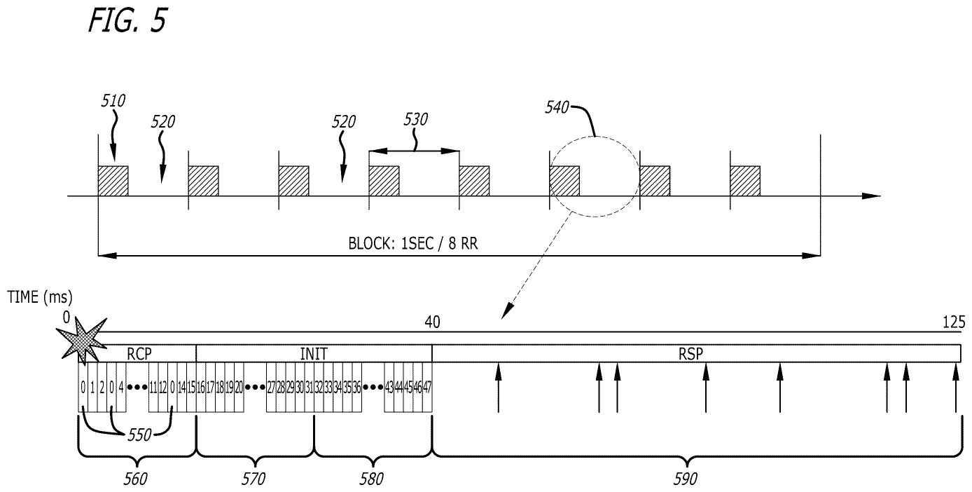

Referring to FIG. 5, a timeline 500 illustrating adaptive repetitive synchronization utilizing multiple transmission slots in accordance with various embodiments of the disclosure is shown. In many embodiments, the timeline 500 allows for the precise scheduling of transmission slots to ensure that critical timing messages are distributed across the network without overlapping with other essential traffic. The timeline 500 is typically organized into a larger structure defined by a ranging block 530. The ranging block 530 represents a macro-level timing unit, such as a one-second interval, which aggregates multiple opportunities for synchronization and ranging into a coherent repeating cycle.

In further embodiments, the ranging block 530 comprises a plurality of ranging rounds 520. The plurality of ranging rounds 520 are distinct operational periods, for example occurring every 125 milliseconds, during which the anchors and tags interact. In various embodiments, not each of the plurality of ranging rounds 520 is utilized for the same purpose; some may be reserved for synchronization while others are allocated for tag updates. By dividing the time domain into these plurality of ranging rounds 520, the system can dynamically allocate capacity based on the current density of tags and the stability of the anchor clocks.

In some embodiments, the timeline 500 highlights an expanded region 540 to illustrate the micro-structure of a specific active round. The expanded region 540 reveals that each round is subdivided into distinct operational phases to prevent signal overlap. One such phase is the Ranging Control Phase (RCP), which is populated by a set of control slot indices 550. The set of control slot indices 550 provide the numerical addressing scheme used to assign specific transmission times to primary and secondary anchors.

In more embodiments, the set of control slot indices 550 includes a first transmission slot 510, which is often designated as “Slot 0.” The first transmission slot 510 typically serves as the default transmission point for the primary anchor to broadcast its synchronization message. In normal operating conditions, the system may rely exclusively on this first transmission slot 510 to maintain clock alignment across the anchor network. Additionally, utilizing the first transmission slot 510 as the standard allows for predictable behavior and minimizes the duty cycle of the transmitting hardware when the radio frequency environment is clean.

In additional embodiments, the set of control slot indices 550 also encompass a second transmission slot 512, which may correspond to “Slot 3” or another non-adjacent position. The second transmission slot 512 is typically utilized as a redundant measure to transmit a duplicate of the synchronization message sent in the first slot. By spacing the second transmission slot 512 apart from the first, the system ensures that a burst of interference or a random collision affecting the start of the round does not result in a complete loss of synchronization data. In certain embodiments, the anchor logic may dynamically enable the second transmission slot 512 only when error rates on the primary slot exceed a predefined threshold.

In yet further embodiments, the set of control slot indices 550 include a third transmission slot 514, such as “Slot 7,” to provide a high level of redundancy. The third transmission slot 514 is generally employed in harsh radio frequency environments where the probability of collision is high due to dense tag populations or external noise. In these scenarios, transmitting the synchronization message a third time significantly increases the likelihood that receiving anchors will successfully decode at least one of the transmissions. This triple-redundancy scheme allows the system to maintain tight synchronization even when a significant percentage of the airtime is congested by uncoordinated tag blinks.

In various embodiments, the timeline 500 progresses from the control phase into an initiation phase 570. The initiation phase 570 is designed to facilitate the setup of two-way ranging exchanges between anchors or between anchors and tags. This phase contains a set of initiation slot indices 580 which are distinct from the control slots. The set of initiation slot indices 580 allow specific device pairs to initiate distance measurement protocols without interfering with the ongoing clock synchronization broadcast in the earlier phase.

In many embodiments, the ranging round concludes with a response phase 590. The response phase 590 constitutes the majority of the ranging round duration and is dedicated to receiving reply messages and unsolicited blinks from asset tags. Because the response phase 590 is significantly longer than the control or initiation phases, it can accommodate the random-access nature of uncoordinated tag transmissions. However, as the density of tags increases, the probability of signals from the response phase 590 bleeding into the subsequent control phase increases, necessitating the adaptive redundancy provided by the multiple transmission slots.

In a non-limiting example, the primary anchor might initially transmit only on the first transmission slot 510 to maintain synchronization with neighboring anchors. If the anchor coordination logic detects a sudden spike in blink interference during the ranging control phase 560, it can dynamically activate redundancy measures for the plurality of ranging rounds 520. Consequently, the primary anchor would broadcast the clock synchronization packet on the first transmission slot 510, the second transmission slot 512, and the third transmission slot 514 within the same duration. This immediate escalation ensures that even if the first two transmissions collide with tag blinks, the third transmission has a high probability of successful delivery, thereby maintaining system stability.

In another instance, the specific arrangement of the set of control slot indices 550 allows for a hierarchical prioritization of anchor communications. When a primary anchor utilizes the first transmission slot 510, the second transmission slot 512, and the third transmission slot 514, the system effectively reserves these specific intervals for the most critical time-alignment data. Secondary anchors, upon receiving the schedule during the initiation phase 570, typically acknowledge this reservation and refrain from transmitting their own ranging polls during these designated slots. If a secondary anchor determines that no remaining slots are available in the ranging control phase 560 due to this redundancy, it may temporarily transition to a passive monitoring state to avoid causing self-interference.

In yet another scenario, the structure of the ranging block 530 facilitates the handling of high-density asset tracking environments. As thousands of tags transmit uncoordinated signals during the response phase 590, the probability of signal bleed-over into adjacent time windows increases. The buffer time provided between the response phase 590 of one of the plurality of ranging rounds 520 and the ranging control phase 560 of the next round helps mitigate this issue. However, if a misconfigured tag persists in transmitting during the ranging control phase 560, the use of the second transmission slot 512 that is spaced-out and third transmission slot 514 allows the infrastructure to bypass the periodic interference pattern created by the rogue device.

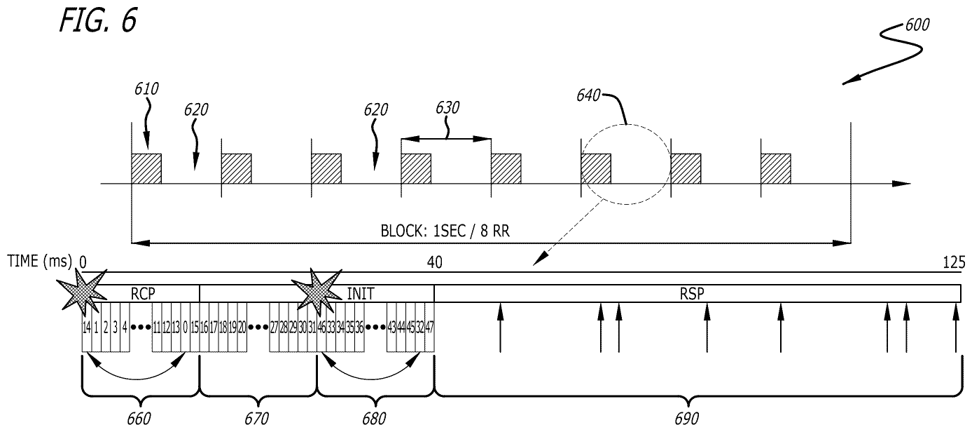

Although a specific embodiment for a timeline 500 for carrying out the various steps, processes, methods, and operations described herein is discussed with respect to FIG. 5, any of a variety of systems and/or devices may be utilized in accordance with embodiments of the disclosure. For example, while the embodiment depicts specific slot indices such as 0, 3, and 7, other non-adjacent slot combinations could be utilized to achieve similar time diversity. The elements depicted in FIG. 5 may also be interchangeable with other elements of FIGS. 6-12 as required to realize a particularly desired embodiment.

Referring to FIG. 6, a conceptual diagram 600 illustrating a dynamic slot allocation state in accordance with various embodiments of the disclosure is shown. In many embodiments, the conceptual diagram 600 depicts the operational state of the network structure after a remediation protocol has been executed to resolve a detected conflict. This state is typically entered automatically by the anchor coordination logic when persistent interference compromises the default synchronization schedule. By visualizing the altered timeline, the conceptual diagram 600 demonstrates how the system preserves critical timing margins without requiring a manual reset of the infrastructure. Furthermore, the conceptual diagram 600 serves as a comparative reference to the standard operating mode shown in previous figures, highlighting the flexibility of the time-division multiplexing scheme.

In further embodiments, the conceptual diagram 600 displays a ranging block interval 630. The ranging block interval 630 functions as the macro-level timing container for the system, defining the repetition rate of the synchronization patterns. In various embodiments, the ranging block interval 630 ensures that all anchors within the cluster maintain a unified concept of time, regardless of their individual slot assignments. This fixed interval allows the system to predictably schedule deep sleep cycles for battery-powered tags, even when the internal slot ordering is in flux. Additionally, the duration of the ranging block interval 630 is typically standardized across the deployment to facilitate seamless roaming for mobile assets.

In additional embodiments, the ranging block interval 630 is composed of a sequence of ranging round activities 610. Each ranging round activity 610 represents an active period where radio frequency transmission and reception occur. The ranging round activity 610 is the fundamental unit of bandwidth allocation, often sized to accommodate a specific number of control and response slots. By modulating the density or frequency of these ranging round activities 610, the system can adapt to varying levels of network congestion. Moreover, the specific arrangement of these activities remains consistent even during interference events to ensure that legacy devices can still track the system heartbeat.

In yet further embodiments, the conceptual diagram 600 identifies an inter-round gap 620 between subsequent activities. The inter-round gap 620 serves as a protective guard band that absorbs timing jitter and processing latency. In some embodiments, the inter-round gap 620 provides a quiet period for the infrastructure to perform background spectral analysis or clear internal buffers. This buffer zone is essential for preventing signal bleed-over between rounds, particularly when clock drift has occurred. Furthermore, the inter-round gap 620 can be dynamically compressed or expanded to fine-tune the duty cycle of the access points.

In some embodiments, the conceptual diagram 600 includes a detailed view 640. The detailed view 640 provides a magnified inspection of the internal slot architecture for a specific ranging round activity 610. This magnification is necessary to visualize the specific index reassignments that constitute the dynamic slot allocation logic. Within the detailed view 640, the distinct phases of operation are delineated, allowing for a precise analysis of where the interference is occurring relative to the control signals. The detailed view 640 essentially acts as a logic analyzer trace, revealing the decision-making process of the anchor coordination engine.

In more embodiments, the detailed view 640 highlights a ranging control phase 660. The ranging control phase 660 is the reserved window for anchor-to-anchor synchronization and is populated by a specific sequence of slot indices. In the specific embodiment depicted, the slot indices within the ranging control phase 660 have been reordered compared to a default linear sequence (e.g., starting with index 14 instead of index 0). This reordering indicates that the system has actively swapped the transmission positions to move critical signals away from noise. Additionally, a collision graphic (starburst) is shown superimposed over the first slot position (index 14), indicating that the persistent interference is still present but has been isolated to a less critical logical address.

In various embodiments, the detailed view 640 transitions into an initiation phase 670. The initiation phase 670 follows the control phase and is dedicated to the transmission of ranging poll messages. This phase ensures that the variable-length transactions associated with setting up tag ranging do not impinge upon the fixed-timing requirements of the control phase. By isolating these activities, the initiation phase 670 maintains the integrity of the downlink communication path. The duration of this phase is typically managed independently of the control phase to allow for flexible scalability.

In still more embodiments, the initiation phase 670 comprises initiation slot indices 680. These initiation slot indices 680 represent the specific time offsets assigned to anchors for contacting tags. In various embodiments, the assignment of the initiation slot indices 680 may be adjusted based on the changes made in the preceding control phase to ensure alignment. The visibility of these indices allows network administrators to verify that the downlink schedule remains valid even after a slot swap event. Furthermore, these indices facilitate the coordination of multiple anchors attempting to range with the same tag simultaneously.

In additional embodiments, the round concludes with a response phase 690. The response phase 690 is the designated interval for receiving uplink signals from the asset tags. Because the response phase 690 occupies the tail end of the ranging round activity 610, it benefits from the stabilized clock domain established in the earlier phases. In many embodiments, the system monitors the response phase 690 for signal-to-noise ratio degradation, which can serve as a secondary trigger for further slot reallocations. This phase represents the payload portion of the cycle where actual location data is harvested.

In a non-limiting example, the system may detect a persistent jammer affecting the first physical time slot of the ranging control phase 660. In response, the anchor coordination logic executes a “swap” operation. It reassigns the logical index “0” (used by the primary anchor) to a later physical time slot that is known to be clean. Simultaneously, it assigns logical index “14” (used by a secondary or receive-only anchor) to the first physical time slot. As depicted in the figure, the collision graphic remains on the first slot (now Index 14), corrupting only the secondary signal, while the critical Index 0 transmission proceeds successfully later in the phase.

In another instance, the conceptual diagram 600 illustrates how the system maintains network awareness of the interference source. By deliberately assigning a valid slot index (e.g., Index 14 in the ranging control phase 660) to the noisy window, the system can continue to measure the magnitude and duration of the collision using the collision graphic as a visual proxy for the noise floor. If the interference ceases, the anchor assigned to Index 14 will successfully receive packets again. This success serves as a signal to the coordination logic that the environment has cleared, potentially triggering a reversion to the default schedule to optimize latency.

In yet another scenario, the reconfiguration shown in the detailed view 640 demonstrates the resilience of the initiation slot indices 680. Despite the shuffling of the control slots to mitigate interference, the initiation indices remain contiguous and orderly. This stability ensures that asset tags, which may have simpler logic than anchors, do not need to be reprogrammed or resynchronized to the new schedule. The tags simply wake up at their expected time relative to the initiation phase 670, unaware that the upstream synchronization slots were dynamically swapped to protect the master clock.

Although a specific embodiment for a conceptual diagram 600 illustrating a dynamic slot allocation state for carrying out the various steps, processes, methods, and operations described herein is discussed with respect to FIG. 6, any of a variety of systems and/or devices may be utilized in accordance with embodiments of the disclosure. For example, the ranging control phase 660 could be expanded to include more slots, allowing for more complex shuffling patterns in extremely dense environments. The elements depicted in FIG. 6 may also be interchangeable with other elements of FIGS. 1-5 and 7-12 as required to realize a particularly desired embodiment.

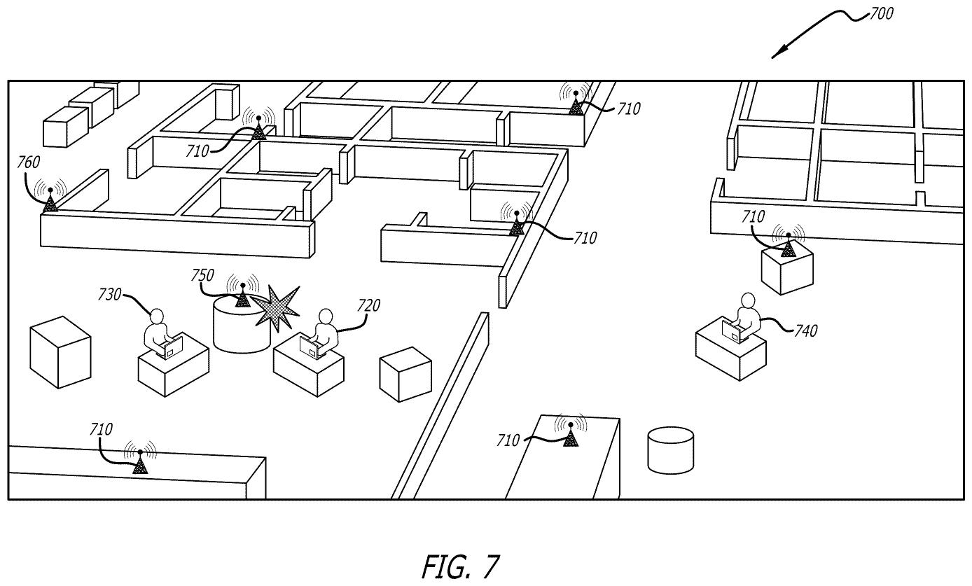

Referring to FIG. 7, a schematic diagram of a physical environment illustrating dynamic anchor role assignment based on tag density in accordance with various embodiments of the disclosure is shown. In many embodiments, the schematic diagram depicts an environment 700. This environment 700 represents the physical space, such as a warehouse, hospital, or office complex, where the real-time location system is deployed. The environment 700 illustrates varying conditions, such as differing levels of tag density or radio frequency interference, that exist in different physical sectors of the facility. By mapping the environment 700, the system can spatially correlate network performance metrics with physical zones to optimize infrastructure behavior. Furthermore, the environment 700 contains various obstacles and multiple anchors and tags, illustrating the complex spatial challenges the system manages during operation.

In further embodiments, the environment 700 includes a plurality of anchors 710 distributed throughout the facility. These anchors 710 represent the Access Points or infrastructure nodes deployed to participate in the synchronization and ranging process. In various embodiments, the anchors 710 maintain wireless links with mobile assets and exchange timing signals with one another to establish a common clock domain. The coordination logic can dynamically swap the roles of each anchor 710, designating them as either primary or secondary nodes based on real-time performance metrics. Consequently, the anchors 710 form a flexible mesh that can adapt its topology to mitigate localized interference.

In additional embodiments, the diagram highlights a primary anchor 750 located within a congested zone. The primary anchor 750 represents the node currently assigned the critical role of master clock source or synchronization leader for the local cluster. In the specific scenario depicted, the primary anchor 750 is shown experiencing a collision, indicated by the collision graphic superimposed over the device. This visual indicator signifies that the primary anchor 750 is suffering from instability due to the high density of nearby tags. Therefore, the primary anchor 750 is identified by the system as an impaired node that requires remediation to preserve network integrity.

In yet further embodiments, the system tracks the location of a first tag 720 and a second tag 730 relative to the infrastructure. The first tag 720 is an asset tag located in close physical proximity to the primary anchor 750. Similarly, the second tag 730 is another asset tag positioned in the same vicinity, contributing to the signal congestion. The presence of multiple tags, specifically the first tag 720 and the second tag 730, creates a high-density cluster that can cause congestion for the nearby anchor. This clustering increases the noise floor and the probability of packet collisions affecting the primary anchor 750, triggering the need for a role adjustment.

In some embodiments, the environment 700 comprises a secondary anchor 760 positioned in a different sector. The secondary anchor 760 is an anchor located in a less congested area, often acting as a passive listener or a redundant node in the default configuration. Because the secondary anchor 760 is physically removed from the immediate interference generated by the cluster near the primary anchor 750, it operates in a cleaner radio frequency environment. The secondary anchor 760 represents a stable candidate that the system can identify and promote to the primary role to resolve the instability at the primary anchor 750. This availability provides the logic with a viable alternative for sourcing synchronization signals.

In various embodiments, a third tag 740 is illustrated within the environment 700. This third tag 740 is located in a different part of the environment, distinct from the congested zone, and is typically near a different anchor. It illustrates the distributed nature of the assets being tracked by the system, showing that while some areas are congested, others may have sparse activity. The tracking of the third tag 740 demonstrates that the system must maintain service continuity across the entire facility even while mitigating localized issues elsewhere. This distribution emphasizes the need for a scalable solution that optimizes specific clusters without disrupting the broader network.

In a non-limiting example, the anchor coordination logic may continuously aggregate collision metrics from the primary anchor 750. If the reporting indicates that the signals from the first tag 720 and the second tag 730 are consistently corrupting the synchronization packets, the system flags the primary anchor 750 as impaired. This determination triggers a search routine to evaluate the health metrics of neighboring devices within the environment 700. The system effectively identifies that the location of the primary anchor 750, while beneficial for coverage, is detrimental for synchronization due to the proximity of the first tag 720.

In another instance, the system executes a dynamic role swap to restore stability to the environment 700. Once the secondary anchor 760 is identified as having clean metrics, the logic promotes the secondary anchor 760 to the primary role and demotes the primary anchor 750 to a secondary or receive-only role. This action shifts the source of the critical clock synchronization packet away from the noise generated by the first tag 720 and the second tag 730. Consequently, the other anchors 710 begin receiving timing updates from the newly promoted secondary anchor 760, ensuring that the system-wide clock remains accurate despite the localized congestion.

In yet another scenario, the system performs a simulation-based prediction before finalizing the role change within the environment 700. The logic momentarily treats the secondary anchor 760 as the primary anchor in a virtual model to predict the resulting or cumulative clock drift relative to the other anchors 710. This cumulative clock drift can be relative to the remainder of the plurality of anchors in the RTLS. If the simulation confirms that the secondary anchor 760 provides better geometric dilution of precision or lower packet loss than the primary anchor 750 currently engaged, the role change is committed. This predictive step ensures that solving the local interference problem near the first tag 720 does not inadvertently degrade the positioning accuracy for the third tag 740 located at the edge of the facility.

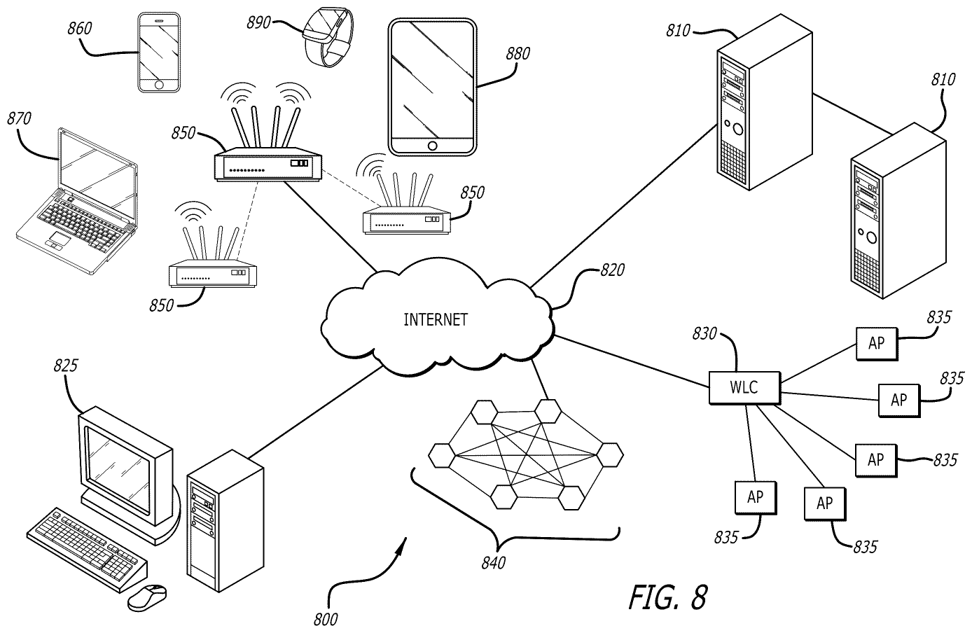

Although a specific embodiment for a schematic diagram of a physical environment illustrating dynamic anchor role assignment based on tag density for carrying out the various steps, processes, methods, and operations described herein is discussed with respect to FIG. 7, any of a variety of systems and/or devices may be utilized in accordance with embodiments of the disclosure. For example, the environment 700 could represent a multi-floor facility where the primary anchor 750 and secondary anchor 760 are located on different vertical levels. The elements depicted in FIG. 7 may also be interchangeable with other elements of FIGS. 8-12 as required to realize a particularly desired embodiment.

Referring to FIG. 8, a schematic diagram of a network deployment environment connecting local access points to remote services in accordance with various embodiments of the disclosure is shown. In many embodiments, the schematic diagram depicts an environment 800. This environment 800 illustrates the broader network context in which the asset tracking system operates, encompassing both on-premise hardware and remote computing resources. The environment 800 serves as the foundational infrastructure that enables the seamless transfer of telemetry data, synchronization signals, and configuration commands between distributed components. By visualizing the environment 800, the system architecture demonstrates how local proximity events are translated into actionable insights accessible from anywhere in the world.

In further embodiments, the environment 800 includes one or more servers 810. These servers 810 represent the backend systems responsible for heavy data processing, persistent storage, and global system management. In various embodiments, the servers 810 can host the Anchor Coordination Logic or the location engine that calculates precise coordinates based on time difference of arrival data. Furthermore, the servers 810 may aggregate historical performance metrics from the edge devices to refine machine learning models used for interference detection.

In additional embodiments, the various components within the environment 800 are interconnected via a network 820. The network 820 represents the communication infrastructure, such as the Internet, a Wide Area Network (WAN), or a private enterprise backbone, that facilitates data transfer. In many embodiments, the network 820 ensures that latency-sensitive synchronization data remains prioritized while handling bulk traffic from other services. Additionally, the network 820 provides the secure tunnels necessary for administrators to remotely configure the local hardware without being physically present at the facility.

In yet further embodiments, the local infrastructure is managed by a wireless LAN controller 830. The wireless LAN controller 830 acts as a centralized aggregation point for the wireless hardware deployed at the edge of the network 820. In some embodiments, the wireless LAN controller 830 is responsible for distributing firmware updates and synchronization schedules to the downstream devices. Moreover, the wireless LAN controller 830 can process real-time alerts regarding interference or anchor instability before passing summarized incidents up to the servers 810.

In some embodiments, the environment 800 features a plurality of access points 835 connected to the wireless LAN controller 830. The access points 835 serve as the physical anchors in the real-time location system, equipped with the necessary radios to communicate with asset tags. In various embodiments, the access points 835 execute the edge logic required for dynamic role assignment, switching between primary and secondary states based on local conditions. These access points 835 act as the bridge between the physical radio frequency environment and the digital network infrastructure.

In more embodiments, the environment 800 may utilize a distributed system 840. The distributed system 840 represents a cluster of computing resources, such as a cloud computing mesh or a distributed database, that augments the capabilities of the standalone servers 810. By leveraging the distributed system 840, the architecture can scale elastically to handle surges in tag density or processing load during peak operational hours. This distributed approach ensures that the failure of a single node does not cripple the entire location service.

In additional embodiments, the connectivity for local devices is facilitated by a local router 850. The local router 850 manages the traffic flow between the wired infrastructure and the wireless edge devices. In many embodiments, the local router 850 enforces quality of service policies to ensure that synchronization packets generated by the access points 835 are not dropped during periods of congestion. Furthermore, the local router 850 provides the physical interface for connecting various local subnets to the broader network 820.

In various embodiments, the environment 800 supports interaction through various user devices, such as a smartphone 860. The smartphone 860 represents a mobile end-user device that can run a “Find” application to locate assets in real-time. In typical scenarios, the smartphone 860 communicates with the servers 810 via the network 820 to request the current coordinates of a specific tag. The smartphone 860 then renders this location data on a map, guiding the user to the asset's physical position.

In further embodiments, the environment 800 includes a laptop 870. The laptop 870 is typically utilized by network administrators or facility managers to monitor the overall health of the system. Through the laptop 870, a user can visualize the topology of the access points 835, identify congested zones, and manually override or at least reassess role assignments if necessary. The laptop 870 acts as the primary interface for deep analytical work and system configuration.

In yet more embodiments, the system interacts with a tablet 880. The tablet 880 offers a portable form factor suitable for mobile workers who need larger screen real estate than a smartphone 860 but more mobility than a laptop 870. For example, hospital staff might use the tablet 880 mounted on a cart to track the location of medical equipment as they move through the wards. The tablet 880 provides a versatile interface for consuming location services in an operational context.

In some embodiments, the environment 800 monitors a wearable device 890. The wearable device 890 represents a tag or tracker worn by personnel for safety or workflow optimization purposes. Unlike static assets, the wearable device 890 moves frequently and unpredictably, testing the system's ability to maintain synchronization and handoff between access points 835. The tracking of the wearable device 890 demonstrates the system's capability to handle diverse asset types within the same infrastructure.

In a non-limiting example, the access points 835 may detect a surge in interference and report this metric to the wireless LAN controller 830. The wireless LAN controller 830 processes this data and determines that a specific primary anchor needs to be reassigned to a stable secondary role. This command is propagated back down to the specific access point 835, which executes the role swap in the next ranging round. Simultaneously, the wireless LAN controller 830 sends a notification to the server 810 to log the event for future predictive analysis.

In another instance, an administrator using the laptop 870 may notice that a specific zone in the facility is experiencing frequent clock drift. Using the management interface, the administrator pushes a new configuration profile to the servers 810. The servers 810 distribute this profile via the network 820 to the wireless LAN controller 830, which subsequently updates the synchronization interval for the relevant access points 835. This entire flow demonstrates the manageability of the distributed infrastructure from a single point of control.

In yet another scenario, a user equipped with the smartphone 860 enters a warehouse looking for a specific pallet. The access points 835 detect the blinks from the pallet's tag and relay the timing data to the distributed system 840. The distributed system 840 computes the precise location and sends the coordinates back to the smartphone 860. The smartphone 860 then displays a wayfinding path, guiding the user directly to the pallet's location within the environment 800.

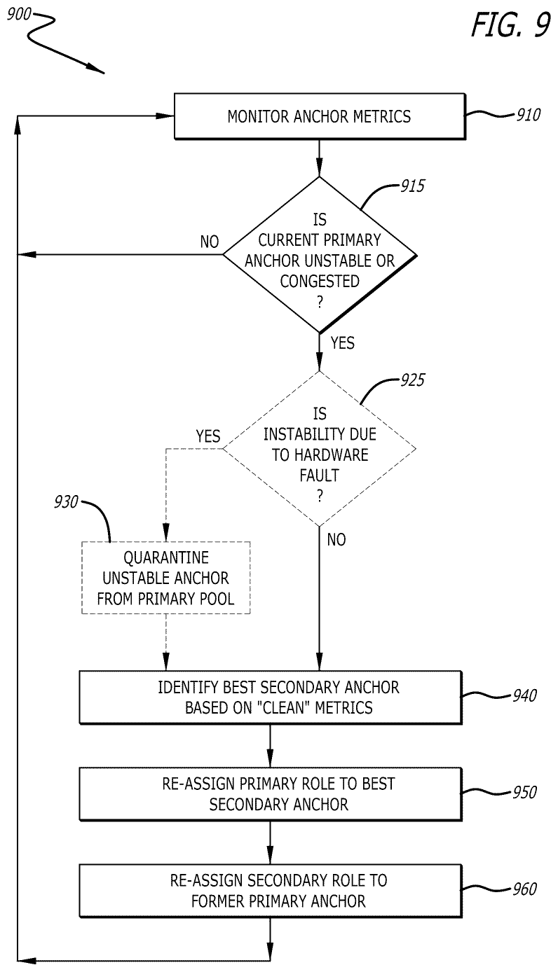

Although a specific embodiment for a schematic diagram of a network deployment environment connecting local access points to remote services for carrying out the various steps, processes, methods, and operations described herein is discussed with respect to FIG. 8, any of a variety of systems and/or devices may be utilized in accordance with embodiments of the disclosure. For example, the functions of the wireless LAN controller 830 could be virtualized and hosted directly on the servers 810. The elements depicted in FIG. 8 may also be interchangeable with other elements of FIGS. 9-12 as required to realize a particularly desired embodiment.

Referring to FIG. 9, a flowchart depicting a process 900 for dynamic anchor role assignment in accordance with various embodiments of the disclosure is shown. In many embodiments, the process 900 can monitor anchor metrics (block 910). This monitoring step often involves collecting real-time data regarding the performance and environmental conditions of each node within the network. As described in the claims, the process monitors one or more anchor metrics associated with a plurality of anchors in communication with the RTLS. For example, the system might track packet collision rates, signal-to-noise ratios, or the number of asset tags currently within range of specific anchors. In some embodiments, the one or more anchor metrics comprise at least one of a local tag density, a collision probability, or a clock drift metric. Ideally, the metrics are aggregated at a central controller to facilitate system-wide decision making.

In further embodiments, the process 900 can determine is current primary anchor unstable or congested (block 915). If it is determined that the primary anchor is operating within acceptable parameters, then the process 900 can once again monitor anchor metrics (block 910). However, if the metrics indicate that the primary anchor is suffering from performance degradation, the process 900 proceeds to evaluate the cause. In various embodiments, this step equates to determining, based on the anchor metrics, that the primary anchor is operating in an impaired state. This impaired state may be due to congestion with the primary anchor or due to an instability of the primary anchor.

In additional embodiments, the process 900 can determine is instability due to hardware fault (block 925). If it is determined that the instability is indeed caused by a hardware fault, such as a failing crystal oscillator, then the process 900 can quarantine unstable anchor from primary pool (block 930). However, if the instability is not due to a hardware fault, for example, if it is caused purely by transient environmental congestion, then the process 900 proceeds to the next selection phase. In the context of the claims, the anchor coordination logic is configured to determine if the impaired state is caused by a hardware fault prior to quarantining the primary anchor. Distinguishing between hardware faults and environmental factors ensures that the system does not permanently penalize a healthy device that happens to be in a busy location.

In some embodiments, the process 900 can quarantine unstable anchor from primary pool (block 930). This action effectively removes the compromised device from consideration for future leadership roles, preventing it from repeatedly destabilizing the network. In various embodiments, the anchor coordination logic is further configured to quarantine the primary anchor from a primary pool upon determining that the primary anchor is operating in the impaired state. The quarantine status may be permanent until a manual maintenance intervention occurs, or temporary, allowing the device to undergo a self-diagnostic routine. For example, an anchor flagged for severe clock drift might be relegated to a receive-only role where its timing inaccuracies do not impact the broader system.

In more embodiments, the process 900 can identify best secondary anchor based on “clean” metrics (block 940). This selection process typically involves scanning the available secondary nodes to find a candidate that exhibits low interference and high stability. As recited in the claims, the process identifies a suitable secondary anchor from the plurality of anchors. The identification of a suitable secondary anchor is based on clean metrics, wherein the clean metrics are indicative of the suitable secondary anchor operating in a non-impaired state. In certain embodiments, the suitable secondary anchor is identified based on a spatial relationship with other anchors in the plurality of anchors.

In still more embodiments, the process 900 can re-assign primary role to best secondary anchor (block 950). Once the optimal candidate is selected, the system issues a command to promote that device to the leader status. In many embodiments, this corresponds to re-assigning the suitable secondary anchor as the new primary anchor. This transition involves the new primary anchor taking over the responsibility of transmitting the clock synchronization packets in the designated time slots. Ideally, this handover is synchronized to occur at a specific frame boundary to minimize disruption to the ongoing ranging rounds.

In yet further embodiments, the process 900 can re-assign secondary role to former primary anchor (block 960). This step ensures that the previously congested or impaired device is relieved of its critical duties. In accordance with the claims, the process re-assigns the current primary anchor to a secondary anchor role. In various embodiments, the former primary anchor transitions to a standard secondary role where it listens for synchronization signals rather than generating them. After this reassignment is complete, the process 900 typically returns to the monitoring state to ensure the new configuration remains stable to adapt to evolving network conditions.

Although a specific embodiment for a process 900 for dynamic anchor role assignment suitable for carrying out the various steps, processes, methods, and operations described herein is discussed with respect to FIG. 9, any of a variety of systems and/or processes may be utilized in accordance with embodiments of the disclosure. For example, the anchor coordination logic identifies the suitable secondary anchor by performing a simulation-based prediction wherein a candidate secondary anchor is momentarily treated as the primary anchor. The elements depicted in FIG. 9 may also be interchangeable with other elements of FIGS. 1-8 and 10-12 as required to realize a particularly desired embodiment.

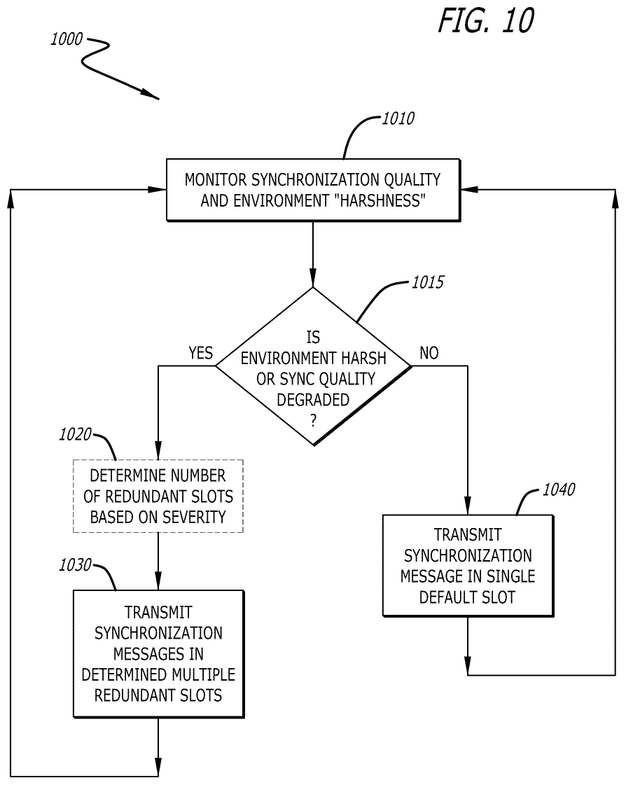

Referring to FIG. 10, a flowchart depicting a process 1000 for adaptive repetitive synchronization based on environmental harshness in accordance with various embodiments of the disclosure is shown. In many embodiments, the process 1000 can monitor synchronization quality and environment “harshness” (block 1010). This monitoring step often involves the anchor coordination logic analyzing the success rate of packet delivery between infrastructure nodes to establish a baseline of network health. As described in the claims, the system is configured to monitor a synchronization quality of a network environment. For example, the system may track the signal-to-noise ratio of received clock synchronization packets or count the number of missed beacons over a sliding time window. In some embodiments, this step utilizes the collision metric data to distinguish between normal operating fluctuations and significant environmental degradation caused by external interference.

In further embodiments, the process 1000 can determine is environment harsh or sync quality degraded (block 1015). If it is determined that the environment is not harsh and the synchronization quality is stable, then the process 1000 can proceed to the standard transmission routine. However, if the metrics indicate that the environment is harsh or the quality is compromised, the process 1000 moves to the remediation phase. In accordance with the claims, this step corresponds to determining that the synchronization quality is degraded. This determination serves as the trigger point for activating the adaptive redundancy mechanisms designed to protect the integrity of the clock domain.

In additional embodiments, if the environment is not harsh, the process 1000 can transmit synchronization message in single default slot (block 1040). This action maintains the standard operational cadence of the network, utilizing the minimum amount of airtime necessary for alignment. As recited in the claims, the anchor coordination logic is configured to transmit the synchronization messages in a single default slot when the synchronization quality is determined to be not degraded. Maintaining transmission in the single default slot when conditions are optimal allows the system to conserve airtime and battery power for secondary anchors. This efficient mode prevents the system from occupying unnecessary bandwidth when the radio frequency spectrum is clean.

In more embodiments, if the environment is determined to be harsh, the process 1000 can determine number of redundant slots based on severity (block 1020). This step involves assessing the magnitude of the interference to scale the response appropriately. Per the claim language, the anchor coordination logic is configured to calculate a number of redundant transmission slots required based on the synchronization quality. For instance, a moderately harsh environment might require only one additional slot, whereas a severely congested environment might necessitate two or more. This calculation ensures that the system applies a proportional amount of error correction resources to the detected problem.

In still more embodiments, the process 1000 can transmit synchronization messages in determined multiple redundant slots (block 1030). This execution step ensures that the timing data is broadcast with sufficient diversity to overcome the detected interference. In accordance with the claims, the process transmits a synchronization message in a default slot and in the determined number of redundant transmission slots within a single ranging round. In various embodiments, the determined number of redundant slots comprises non-consecutive time slots within a ranging round to maximize time diversity. This action significantly increases the probability that at least one transmission avoids collision and reaches the secondary anchors.

In a non-limiting example, the process 1000 might initially detect a slight degradation in synchronization quality due to a passing vehicle obstructing the line of sight. In response, the logic calculates that a single redundant slot is sufficient to overcome this transient issue. Consequently, the primary anchor transmits the synchronization packet in the default Slot 0 and repeats it in Slot 3. This specific redundancy pattern allows the system to maintain lock without consuming the bandwidth required for a triple-transmission scheme.

In another instance, the anchor coordination logic utilizes the determined number of redundant slots to manage the energy consumption of the infrastructure. If the severity calculation indicates a critical failure of the primary slot, the system may maximize redundancy by also transmitting in alternate, later slots like 3, and 11 etc. However, as the interference subsides, the logic actively reduces the count. As described in the claims, the anchor coordination logic is configured to reduce the number of redundant slots if a collision statistic indicates successful reception of the synchronization messages over a threshold period. This threshold period can be related to other reception statistics or various other statistics.

In yet another scenario, the process 1000 coordinates the transmission of synchronization messages in determined multiple redundant slots with the listening schedules of the secondary anchors. When the primary anchor broadcasts on multiple slots, the secondary anchors must be aware of this pattern to avoid interpreting the redundant packets as new, distinct synchronization events. The system includes a sequence number or a specific flag within the payload of the redundant messages. This allows the receiving nodes to identify the packet as a duplicate and use it solely for time-of-arrival refinement or error correction.

Although a specific embodiment for a process 1000 for adaptive repetitive synchronization based on environmental harshness suitable for carrying out the various steps, processes, methods, and operations described herein is discussed with respect to FIG. 10, any of a variety of systems and/or processes may be utilized in accordance with embodiments of the disclosure. For example, the determination of the number of redundant slots could be based on a predictive machine learning model rather than a static threshold. The elements depicted in FIG. 10 may also be interchangeable with other elements of FIGS. 1-9 and 11-12 as required to realize a particularly desired embodiment.

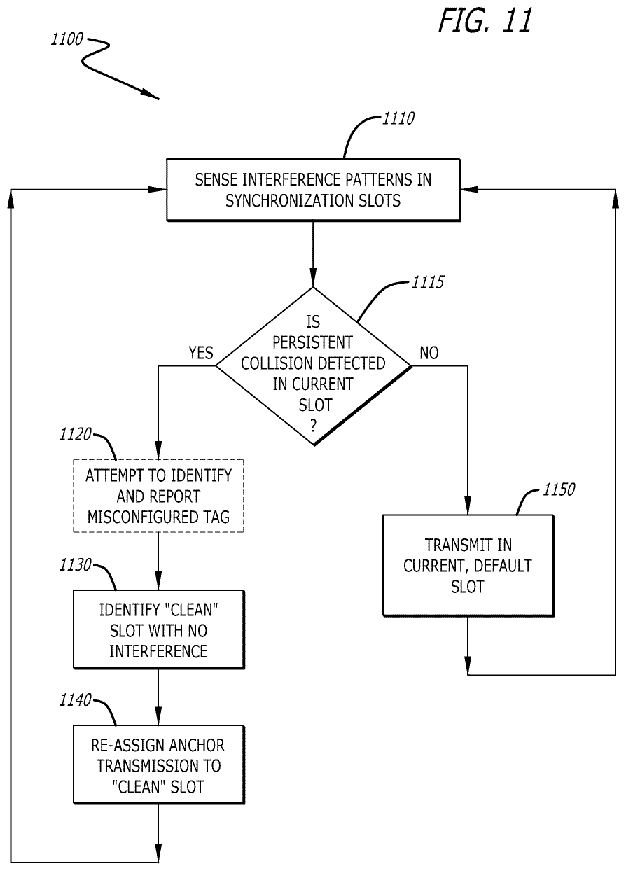

Referring to FIG. 11, a flowchart depicting a process 1100 for dynamic synchronization slot allocation and interference sensing in accordance with various embodiments of the disclosure is shown. In many embodiments, the process 1100 can sense interference patterns in synchronization slots (block 1110). This step typically involves the anchors actively listening to the channel during reserved time intervals to detect unexpected energy or signals. As described in the claims, the anchor coordination logic is configured to aggregate interference metrics collected by the plurality of anchors to construct a network-wide interference map. This map allows the anchor coordination logic to visualize which specific time slots are consistently compromised across different physical zones of the facility.

In further embodiments, the process 1100 can determine is persistent collision detected in current slot (block 1115). If it is determined that no persistent collision is present, indicating that the channel is clear or that collisions are sporadic and random, then the process 1100 can transmit in current, default slot (block 1150). Maintaining the transmission in the current, default slot preserves the stability of the network timing and avoids unnecessary reconfiguration overhead. However, if a persistent collision is detected, indicating that the primary anchor is operating in an impaired state due to congestion, the process 1100 initiates a remediation workflow. This distinction between sporadic noise and persistent collisions prevents the system from reacting unnecessarily to transient interference events that do not threaten long-term stability.

In some optional embodiments, the process 1100 can attempt to identify and report misconfigured tag (block 1120). In some scenarios, the persistent collision is caused by an asset tag transmitting at an interval that inadvertently aligns with the synchronization schedule. By analyzing the periodicity of the interference, the system may be able to identify the specific device ID causing the disruption and flag it for administrative review. This step allows for root-cause correction rather than just symptom management, enabling network administrators to reconfigure the rogue device.

In more embodiments, the process 1100 can identify “clean” slot with no interference (block 1130). This identification is often based on clean metrics collected during the sensing phase, which indicate slots that are operating in a non-impaired state. The logic scans the available schedule to find a time slot where the noise floor is low and no other critical transmissions are scheduled. In accordance with the claims, the identification of a suitable secondary anchor or slot is based on clean metrics derived from the real-time monitoring of the environment.

In still more embodiments, the process 1100 can re-assign anchor transmission to a “clean” slot (block 1140). This step involves instructing the primary anchor to utilize the specific transmission slot identified in the previous step. By moving the synchronization broadcast to a clear channel, the system restores the stability of the clock domain. Per the claim language, the anchor coordination logic is configured to instruct the new primary anchor to utilize a specific transmission slot based on the network-wide interference map to minimize collisions.

In yet further embodiments, the process 1100 can transmit in current, default slot (block 1150). This step confirms that the anchor continues its standard operation without modification when the environment is stable. By validating the current configuration, the system ensures that resources are not wasted on unnecessary channel hopping. This steady state allows the secondary anchors to maintain their lock on the primary clock source without needing to re-scan the schedule. In various embodiments, this step is the default state of the system until an alert threshold is triggered by the monitoring logic.

Although a specific embodiment for a process 1100 for dynamic synchronization slot allocation and interference sensing suitable for carrying out the various steps, processes, methods, and operations described herein is discussed with respect to FIG. 11, any of a variety of systems and/or processes may be utilized in accordance with embodiments of the disclosure. For example, the identification of the clean slot could be performed by a centralized server rather than the local anchor processing. The elements depicted in FIG. 11 may also be interchangeable with other elements of FIGS. 1-10 and 12 as required to realize a particularly desired embodiment.

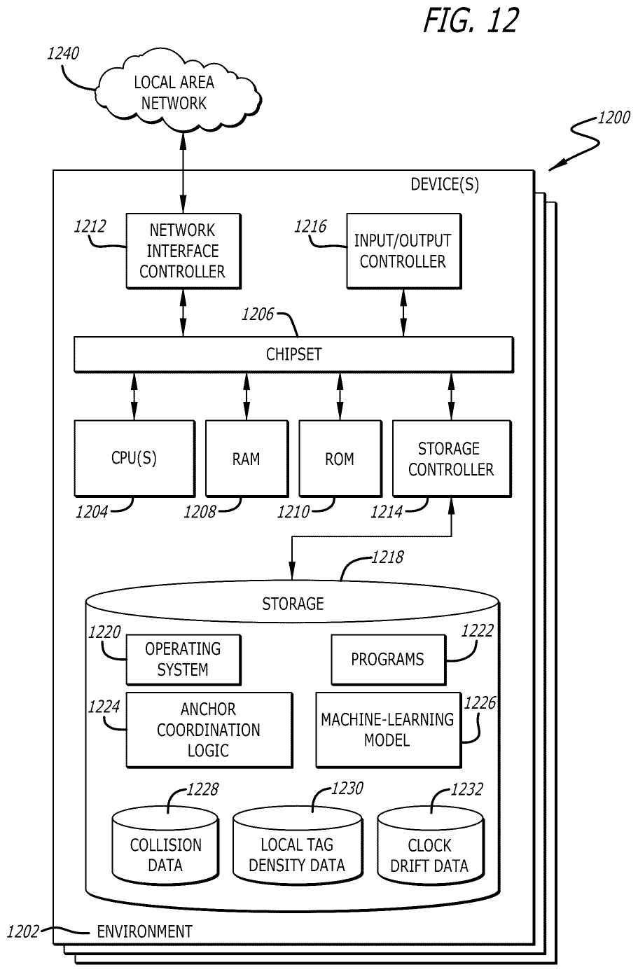

Referring to FIG. 12, a conceptual block diagram for a device suitable for configuration with an anchor coordination logic 1224 in accordance with various embodiments of the disclosure is shown. The embodiment of the conceptual block diagram depicted in FIG. 12 can illustrate a conventional network device, personal computer, mobile device, server, laptop, tablet, network appliance, e-reader, smartphone, wearable device, or other computing device, and can be utilized to execute any of the application and/or logic components presented herein. The device 1200 may, in many non-limiting examples, correspond to physical devices or to virtual resources described herein.

In many embodiments, the device 1200 may include an environment 1202 such as a baseboard or “motherboard,” in physical embodiments that can be configured as a printed circuit board with a multitude of components or devices connected by way of a system bus or other electrical communication paths. Conceptually, in virtualized embodiments, the environment 1202 may be a virtual environment that encompasses and executes the remaining components and resources of the device 1200. In more embodiments, the processor(s) 1204, such as, but not limited to, central processing units (“CPUs”) can be configured to operate in conjunction with a chipset 1206. The processor(s) 1204 can be standard programmable CPUs that perform arithmetic and logical operations necessary for the operation of the device 1200.

In a number of embodiments, the processor(s) 1204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1206 may provide an interface between the processor(s) 1204 and the remainder of the components and devices within the environment 1202. The device 1200 can incorporate different types of processors to enhance performance and efficiency across various tasks. A central processing unit (CPU) can handle primary processing tasks such as general logics, AI, and other inputs, while a graphics processing unit (GPU) can be specialized for various compute and inference tasks. Digital signal processors (DSPs) may manage audio processing, delivering high-quality sound without burdening the CPU.

In portable devices, systems on a chip (SoCs) can be configured to integrate the CPU, GPU, memory, and peripherals to balance performance and efficiency. In some embodiments, application-specific integrated circuits (ASICs) can optimize specific functions like cryptographic processing, while neural processing units (NPUs) accelerate AI and machine learning tasks. Some high-end devices may also include physics processing units (PPUs) to handle complex physics calculations. However, those skilled in the art will recognize that the device 1200 can any variety or combination of processor(s) 1204 as needed to satisfy the desired application.

The chipset 1206 can provide an interface to a random-access memory (“RAM”) 1208, which can be used as the main memory in the device 1200 in some embodiments. The chipset 1206 can further be configured to provide an interface to a computer-readable storage medium such as a read-only memory (ROM 1210) or non-volatile RAM (“NVRAM”) for storing basic routines that can help with various tasks such as, but not limited to, starting up the device 1200 and/or transferring information between the various components and devices. The ROM 1210 or NVRAM can also store other application components necessary for the operation of the device 1200 in accordance with various embodiments described herein.

Additional embodiments of the device 1200 can be configured to operate in a networked environment using logical connections to remote computing devices and computer systems through a network, such as the local area network 1240. The chipset 1206 can include functionality for providing network connectivity through a network interface controller (NIC 1212), which may comprise a gigabit Ethernet adapter or similar component. The NIC 1212 can be capable of connecting the device 1200 to other devices over the local area network 1240. It is contemplated that a NIC 1212 or multiple may be present in the device 1200, connecting the device to other types of networks and remote systems, such as the Internet.

In further embodiments, the device 1200 can be connected to a storage 1218 that provides non-volatile storage for data accessible by the device 1200. The storage 1218 can, for instance, store an operating system 1220, and/or programs 1222. In various embodiments, the storage 1218 can be connected to the environment 1202 through a storage controller 1214 connected to the chipset 1206. In certain embodiments, the storage 1218 can consist of one or more physical storage units. The storage controller 1214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

In additional embodiments, the device 1200 can store data within the storage 1218 by transforming the physical state of the physical storage units to reflect the information being stored. The specific transformation of physical state can depend on various factors. Examples of such factors can include, but are not limited to, the technology used to implement the physical storage units, whether the storage 1218 is characterized as primary or secondary storage, and the like. In addition to the storage 1218 described above, certain embodiments of the device 1200 may also have access to other computer-readable storage media to store and retrieve information, such as program modules, data structures, or other data.

It should be appreciated by those skilled in the art that computer-readable storage media is any available media that provides for the non-transitory storage of data and that can be accessed by the device 1200. In some examples, operations performed by a cloud computing network, and or any components included therein, may be supported by one or more devices similar to device 1200. Stated otherwise, some or all of the operations performed by the cloud computing network, and or any components included therein, may be performed by a device 1200 or multiple operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1218 can store an operating system 1220 utilized to control the operation of the device 1200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized.

The storage 1218 can store other system or application programs and data utilized by the device 1200. In many additional embodiments, the storage 1218 or other computer-readable-storage media is encoded with computer-executable instructions which, when loaded into the device 1200, may transform it from a general-purpose computing system into a special-purpose computer capable of implementing the embodiments described herein. These computer-executable instructions may be stored as application and transform the device 1200 by specifying how the processor(s) 1204 can transition between states, as described above.

In some embodiments, the device 1200 has access to computer-readable storage media storing computer-executable instructions which, when executed by the device 1200, perform the various processes described herein. In certain embodiments, the device 1200 can also include computer-readable storage media having instructions stored thereupon for performing any of the other computer-implemented operations described herein.

In many embodiments, the anchor coordination logic 1224 may be configured to provide the primary operational intelligence for the device 1200. This logic can be executed by the processor(s) 1204 and can be configured to carry out the processes described herein. For instance, the anchor coordination logic 1224 can be responsible for monitoring synchronization quality across the network and detecting if a primary anchor is operating in an impaired state due to congestion or instability. This anchor coordination logic 1224 can then execute remediation protocols, such as initiating a role swap between a primary anchor and a secondary anchor.

In further embodiments, the anchor coordination logic 1224 can be configured to dynamically reallocate synchronization transmission slots. This logic may access the collision data 1228 to identify persistent interference patterns and subsequently instruct the network interface controller to shift broadcasts to clean slots. Upon receiving confirmation of the new slot assignment, the anchor coordination logic 1224 can update the schedule for neighboring devices to maintain system-wide alignment. This logic may also be configured to trigger a quarantine of the device 1200 if internal metrics indicate a hardware fault affecting the reliability of the clock source.

In a number of embodiments, the storage 1218 can be configured to store collision data 1228. This data can represent the aggregated interference metrics collected from the radio frequency environment. The collision data 1228 can store a historical log of packet error rates, signal-to-noise ratios, and specific time slot indices where collisions have occurred. This data can be accessed by the anchor coordination logic 1224 to determine and retrieve a map of clean and dirty slots suitable for dynamic allocation.

In additional embodiments, the collision data 1228 can be generated and updated via continuous monitoring of the ranging control phase. This data may be updated based on real-time feedback from the receiver hardware, allowing the system to detect the onset of persistent interference from misconfigured tags or external noise sources. The collision data 1228 may be a single, local file used for immediate decision making, or it may be part of a distributed interference map shared among multiple anchors to coordinate network-wide frequency agility.

In more embodiments, the storage 1218 may also store local tag density data 1230. This data can include the census information regarding the asset tags currently operating within the vicinity of the device 1200. For example, the local tag density data 1230 may store the unique identifiers, blink rates, and signal strengths of all tags detected during the response phase. This data may be used by the anchor coordination logic 1224 to calculate the collision probability for specific zones and determine if the current node is too congested to effectively serve as a primary synchronization source.

In still more embodiments, the storage 1218 can be configured to store clock drift data 1232. This data can include the performance metrics related to the timing stability of the device 1200. The clock drift data 1232 may store historical measurements of clock skew relative to the primary anchor or the system master clock. This data can be utilized by the coordination logic to qualify the device 1200 for leadership roles or to identify hardware degradation that requires maintenance.

In yet further embodiments, the clock drift data 1232 can also store the rules and thresholds for determining acceptable synchronization tolerances. For instance, this data may store the maximum allowable drift in parts per million (ppm) before an anchor must be demoted or quarantined. This data can be configurable to allow an administrator to tune the sensitivity of the stability checks based on the precision requirements of the specific deployment environment.

In various embodiments, the storage 1218 can also store one or more machine-learning model(s) 1226. These models can include the trained algorithms used for advanced decision making, such as motion classification or predictive interference modeling. For instance, the machine-learning model(s) 1226 may include a neural network or decision tree that analyzes sensor data to distinguish between routine transport vibration and significant motion events. These machine-learning model(s) 1226 may be trained on historical datasets and deployed on the device 1200 to enable edge-based inference without constant cloud connectivity.

In certain embodiments, the machine-learning model(s) 1226 may also include predictive models for anticipating ′ag density shifts. In such an embodiment, the model might predict future congestion based on time-of-day patterns, allowing the system to preemptively adjust synchronization schedules. In other embodiments, the machine-learning model(s) 1226 may include “evaluator” models, which are specialized models used to assess the confidence level of a received signal or the likelihood that a specific slot will remain clean, which is then used to inform the slot reallocation process.

In still further embodiments, the device 1200 can also include one or more input/output controllers 1216 for receiving and processing input from a number of input devices, such as a keyboard, a mouse, a touchpad, a touch screen, an electronic stylus, or other type of input device. Similarly, input/output controllers 1216 can be configured to provide output to a display, such as a computer monitor, a flat panel display, a digital projector, a printer, or other type of output device.

Those skilled in the art will recognize that the device 1200 might not include all of the components shown in FIG. 12 and can include other components that are not explicitly shown or might utilize an architecture completely different than that shown in. As described above, the device 1200 may support a virtualization layer, such as one or more virtual resources executing on the device 1200. In some examples, the virtualization layer may be supported by a hypervisor that provides one or more virtual machines running on the device 1200 to perform functions described herein. The virtualization layer may generally support a virtual resource that performs at least a portion of the techniques described herein.

Although a specific embodiment for a device suitable for configuration with an anchor coordination logic 1224 suitable for carrying out the various steps, processes, methods, and operations described herein is discussed with respect to FIG. 12, any of a variety of systems and/or devices may be utilized in accordance with embodiments of the disclosure. For example, the anchor coordination logic 1224 could be executed within a distributed cloud computing environment rather than a single physical device. It is contemplated that the elements depicted in FIG. 12 may also be interchangeable with other elements or combined in various ways as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network controller, comprising:
a processor;
at least one network interface controller configured to communicate with a real-time location system (RTLS); and
a memory communicatively coupled to the processor, wherein the memory comprises an anchor coordination logic that is configured to:
monitor one or more anchor metrics associated with a plurality of anchors in communication with the RTLS, wherein at least one of the plurality of anchors is assigned as a primary anchor;
determine, based on the anchor metrics, that the primary anchor is operating in an impaired state;
identify a suitable secondary anchor from the plurality of anchors;
re-assign the primary anchor to a secondary anchor role; and
re-assign the suitable secondary anchor as a new primary anchor.

2. The network controller of claim 1, wherein the anchor coordination logic is configured to first establish communication with the plurality of anchors within the RTLS.

3. The network controller of claim 1, wherein the impaired state is due to congestion with the primary anchor.

4. The network controller of claim 1, wherein the impaired state is due to an instability of the primary anchor.

5. The network controller of claim 1, wherein identifying the suitable secondary anchor is based on clean metrics.

6. The network controller of claim 5, wherein the clean metrics are indicative of the suitable secondary anchor operating in a non-impaired state.

7. The network controller of claim 1, wherein the one or more anchor metrics comprise at least one of a local tag density, a collision probability, or a clock drift metric.

8. The network controller of claim 1, wherein the anchor coordination logic is further configured to quarantine the primary anchor from a primary pool upon determining that the primary anchor is operating in the impaired state.

9. The network controller of claim 8, wherein the anchor coordination logic is configured to determine if the impaired state is caused by a hardware fault prior to quarantining the primary anchor.

10. The network controller of claim 1, wherein the anchor coordination logic identifies the suitable secondary anchor by performing a simulation-based prediction wherein a candidate secondary anchor is momentarily treated as the primary anchor.

11. The network controller of claim 1, wherein the suitable secondary anchor is identified based on a spatial relationship with other anchors in the plurality of anchors.

12. The network controller of claim 1, wherein the anchor coordination logic is configured to periodically reassess role assignments of the plurality of anchors to adapt to evolving network conditions.

13. The network controller of claim 1, wherein the anchor coordination logic is configured to aggregate interference metrics collected by the plurality of anchors to construct a network-wide interference map.

14. The network controller of claim 13, wherein the anchor coordination logic is configured to instruct the new primary anchor to utilize a specific transmission slot based on the network-wide interference map to minimize collisions.

15. The network controller of claim 1, wherein the suitable secondary anchor is selected to minimize a cumulative clock drift relative to a remainder of the plurality of anchors in the RTLS.

16. An access point, comprising:
a processor;
a transceiver configured to transmit synchronization messages to a plurality of anchors in a real-time location system (RTLS); and
a memory communicatively coupled to the processor, wherein the memory comprises a anchor coordination logic that is configured to:
monitor a synchronization quality of a network environment;
determine that the synchronization quality is degraded;
calculate a number of redundant transmission slots required based on the synchronization quality; and
transmit a synchronization message in a default slot and in the determined number of redundant transmission slots within a single ranging round.

17. The access point of claim 16, wherein the anchor coordination logic is configured to transmit the synchronization messages in a single default slot when the synchronization quality is determined to be not degraded.

18. The access point of claim 16, wherein the determined number of redundant slots comprises non-consecutive time slots within a ranging round.

19. The access point of claim 16, wherein the anchor coordination logic is configured to reduce the number of redundant slots if a collision statistic indicates successful reception of the synchronization messages over a threshold period.

20. A method of dynamic anchor coordination, comprising:
monitoring, by a network controller, one or more anchor metrics associated with a plurality of anchors in communication with a real-time location system (RTLS), wherein at least one of the plurality of anchors is assigned as a primary anchor;
determining, by the network controller, based on the anchor metrics, that the primary anchor is operating in an impaired state;
identifying, by the network controller, a suitable secondary anchor from the plurality of anchors;
re-assigning, by the network controller, the primary anchor to a secondary anchor role; and
re-assigning, by the network controller, the suitable secondary anchor as a new primary anchor.
